(19) United States
(12) Patent Application Publication
(10) Pub. No.: US 2025/0055635 A1
(43) Pub. Date: Feb. 13, 2025

(54) METHOD AND DEVICE FOR REPORTING CHANNEL STATE INFORMATION IN WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 18/792,063

(22) Filed: Aug. 1, 2024

(30) Foreign Application Priority Data
Aug. 3, 2023 (KR) 10-2023-0101858

(51) Int. Cl. H04L 5/00; H04B 7/06

(52) U.S. Cl. CPC H04L 5/0051; H04B 7/0626; H04B 7/0632

(57) ABSTRACT

The disclosure relates to a 5G or 6G communication system for supporting a higher data transmission rate. According to various embodiments, a method performed by a user equipment (UE) in a wireless communication system, the method comprising: receiving, from a base station, information configuring a channel state information-reference signal (CSI-RS) resource with more than 32 antenna ports, wherein the CSI-RS resource is an aggregation of a plurality of CSI-RS resources; and receiving, from the base station, a CSI-RS on the CSI-RS resource, wherein each of the plurality of CSI-RS resources has an equal number of antenna ports, and wherein a number of the plurality of CSI-RS resources is one of two, three, or four.

### CROSS-REFERENCE TO RELATED APPLICATION

This application is based on and claims priority under 35 U.S.C. § 119 to Korean Patent Application No. 10-2023-0101858 filed on Aug. 3, 2023, in the Korean Intellectual Property Office, the disclosure of which is incorporated by reference herein in its entirety.

### BACKGROUND

### 1. Field

The disclosure relates to an operation of a terminal and a base station in a wireless communication system. Specifically, the disclosure relates to a method of reporting channel state information in a wireless communication system, and a device capable of performing same.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### SUMMARY

A disclosed embodiment is to provide a method and a device enabling effective provision of a service in a mobile communication system.

According to various embodiments, a method performed by a user equipment (UE) in a wireless communication system, the method comprising: receiving, from a base station, information configuring a channel state information-reference signal (CSI-RS) resource with more than 32 antenna ports, wherein the CSI-RS resource is an aggregation of a plurality of CSI-RS resources; and receiving, from the base station, a CSI-RS on the CSI-RS resource, wherein each of the plurality of CSI-RS resources has an equal number of antenna ports, and wherein a number of the plurality of CSI-RS resources is one of two, three, or four.

A disclosed embodiment provides a method and a device enabling effective provision of a service in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of bandwidth part configuration in a wireless communication system according to an embodiment of the disclosure;

FIG. 4 illustrates a beam application time which may be considered when a unified TCI scheme is used in a wireless communication system according to an embodiment of the disclosure;

FIG. 5 illustrates another MAC-CE structure for activation and indication of a joint TCI state or a separate DL or UL TCI state in a wireless communication system according to an embodiment of the disclosure;

FIG. 6 illustrates an example of an aperiodic CSI reporting method according to an embodiment of the disclosure;

FIG. 7 illustrates an example of control resource set configuration of a downlink control channel in a wireless communication system; according to an embodiment of the disclosure;

FIG. 8 illustrates a structure of a downlink control channel in a wireless communication system according to an embodiment of the disclosure;

FIG. 9 illustrates a connection relation between an antenna structure of a base station and CSI-RS resources in a wireless communication system according to an embodiment of the disclosure;

FIG. 10 illustrates restrictions on CSI-RS resource reception and channel estimation in a wireless communication system according to an embodiment of the disclosure;

FIG. 11 illustrates an operation of a terminal according to an embodiment of the disclosure;

FIG. 12 illustrates an operation of a base station according to an embodiment of the disclosure;

FIG. 13 illustrates a structure of a UE in a wireless communication system according to an embodiment of the disclosure; and

FIG. 14 illustrates a structure of a base station in a wireless communication system according to an embodiment of the disclosure.

### DETAILED DESCRIPTION

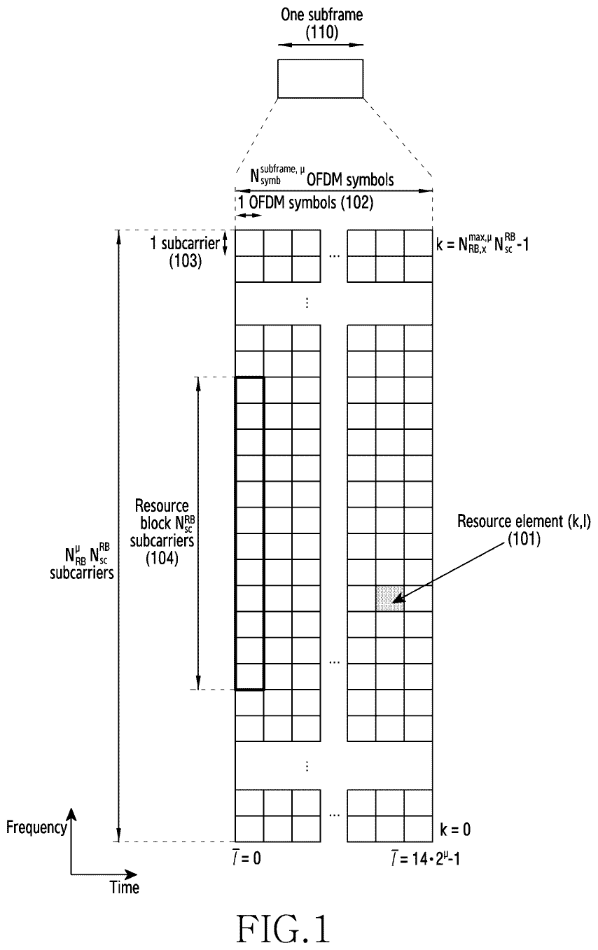

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other (for example, so as to establish orthogonality).

Since a 5G communication system, which is a post-LTE communication system, may freely reflect various requirements of users, service providers, and the like, services satisfying various requirements may be supported. The services considered in the 5G communication system include enhanced mobile broadband (eMBB) communication, massive machine-type communication (mMTC), ultra-reliability low-latency communication (URLLC), and the like.

The eMBB aims at providing a data rate higher than that supported by existing LTE, LTE-A, or LTE-Pro. For example, in the 5G communication system, the eMBB may provide a peak data rate of 20 Gbps in the downlink and a peak data rate of 10 Gbps in the uplink for a single base station. Furthermore, the 5G communication system may provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, the IoT may support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC may be configured to be inexpensive, and may require a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC may provide communication with ultra-low latency and ultra-high reliability. For example, a service supporting URLLC may satisfy an air interface latency of less than 0.5 ms, and may also requires a packet error rate of 10-5 or less. Therefore, for the services supporting URLLC, a 5G system may provide a transmit time interval (TTI) shorter than those of other services, and also may require a design for assigning a large number of resources in a frequency band in order to secure reliability of a communication link.

The three services in 5G (for example, eMBB, URLLC, and mMTC) may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

### [NR Time-Frequency Resources]

Hereinafter, a frame structure of a 5G system will be described in more detail with reference to the accompanying drawings.

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

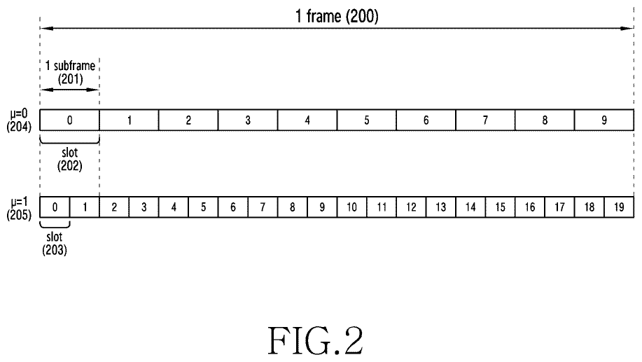

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 millisecond (ms), and thus one frame 200 may include a total of ten subframes 201. One slot 202 or 203 may be defined as 14 OFDM symbols (for example, the number of symbols per one slot N_{symb}^{slot}=14). One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. For example, the number of slots per one subframe Nₛₗₒₜ^{subframeμ} may differ depending on the subcarrier spacing configuration value u, and the number of slots per one frame Nₛₗₒₜ^{frame,μ} slot may differ accordingly. Nₛₗₒₜ^{subframe,μ} and Nₛₗₒₜ^{frame,μ} slot may be defined according to each subcarrier spacing configuration u as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, bandwidth part (BWP) configuration in a 5G communication system will be described in detail with reference to the accompanying drawings.

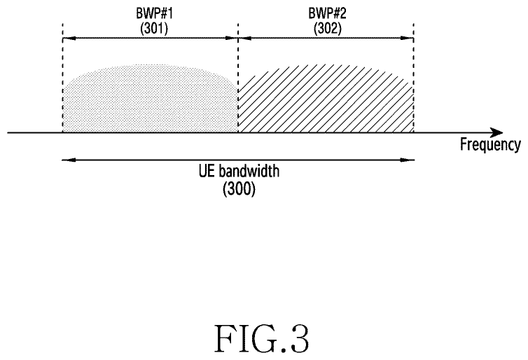

FIG. 3 illustrates an example of bandwidth part configuration in a wireless communication system according to an embodiment of the disclosure.

FIG. 3 illustrates an example in which a UE bandwidth 300 is configured to include two bandwidth parts, for example, bandwidth part #1 (BWP #1) 301 and bandwidth part #2 #2 (BWP #2) 302. A base station may configure one or multiple bandwidth parts for a UE, and may configure the following pieces of information with regard to each bandwidth part as given in Table 2 below.

TABLE 2

```
BWP ::=  SEQUENCE {
  bwp-Id BWP-Id,
  (bandwidth part identifier)
  locationAndBandwidth INTEGER (1..65536),
  (bandwidth part location)
  subcarrierSpacing ENUMERATED
    {n0, n1, n2, n3, n4, n5},
  (subcarrier spacing)
  cyclicPrefix ENUMERATED { extended }
  (cyclic prefix)
}
```

Of course, the above example is not limiting, and in addition to the configuration information given above, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not to activate a configured bandwidth part may be transferred from the base station to the UE semi-statically through RRC signaling, or dynamically through downlink control information (DCI).

According to some embodiments, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource set #0 through the MIB. In addition, the base station may notify the UE of configuration information regarding the monitoring cycle and occasion with regard to control resource set #0 (for example, configuration information regarding search space #0) through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to some embodiments, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (i.e., CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined as given in Table 3 below, for example.

TABLE 3

| | NR Slot | BWP switch delay | |
|---|---|---|---|
| | length | T_{BWP} (slots) | |
| μ | (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCSafter BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the changed new bandwidth part. If the base station wants to schedule a data channel by using the new bandwidth part, the base station may determine time domain resource allocation regarding the data channel in consideration of the UE's bandwidth part change delay time (T_{BWP}). For example, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change may indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Unified TCI State]

Hereinafter, a single TCI state indication and activation method based on a unified TCI scheme is described. The unified TCI scheme may mean a scheme of integral management through a TCI state instead of transmission and reception beam management schemes having been classified as a TCI state scheme used in downlink reception of a UE and a spatial relation info scheme used in uplink transmission in conventional Rel-15 and 16. Therefore, in a case where a UE receives an indication from a base station, based on the unified TCI scheme, the UE may perform beam management even for uplink transmission by using a TCI state. If the higher layer signaling TCI-State having the higher layer signaling tci-stateId-r17 is configured for a UE by a base station, the UE may perform an operation based on the unified TCI scheme by using the TCI-State. TCI-State may exist in two types including a joint TCI state and a separate TCI state.

The first type is a joint TCI state, and all TCI states to be applied to uplink transmission and downlink reception may be indicated to a UE by a base station through one value of TCI-State. If joint TCI state-based TCI-state is indicated to the UE, a parameter to be used in downlink channel estimation may be indicated to the UE by using an RS corresponding to qcl-Type1 in the joint TCI state-based TCI-state, and a parameter to be used as a downlink reception beam or reception filter may be indicated thereto by using an RS corresponding to qcl-Type2. If joint TCI state-based TCI-state is indicated to the UE, a parameter to be used as an uplink transmission beam or transmission filter may be indicated to the UE by using an RS corresponding to qcl-Type2 in a corresponding joint DL/UL TCI state-based TCI-state. If a joint TCI state is indicated to the UE, the UE may apply the same beam to uplink transmission and downlink reception.

The second type is a separate TCI state, and a UL TCI state to be applied to uplink transmission and a DL TCI state to be applied to downlink reception may be individually indicated to a UE by a base station. If a UL TCI state is indicated to the UE, a parameter to be used as an uplink transmission beam or transmission filter may be indicated to the UE by using a reference RS or a source RS configured in the UL TCI state. If a DL TCI state is indicated to the UE, a parameter to be used in downlink channel estimation may be indicated to the UE by using an RS corresponding to qcl-Type1 configured in the DL TCI state, and a parameter to be used as a downlink reception beam or reception filter may be indicated thereto by using an RS corresponding to qcl-Type2.

If a DL TCI state and a UL TCI state are indicated to the UE together, a parameter to be used as an uplink transmission beam or transmission filter may be indicated to the UE by using a reference RS or a source RS configured in the UL TCI state, a parameter to be used in downlink channel estimation may be indicated to the UE by using an RS corresponding to qcl-Type1 configured in the DL TCI state, and a parameter to be used as a downlink reception beam or reception filter may be indicated thereto using an RS corresponding to qcl-Type2. If the reference RSs or source RSs configured in the DL TCI state and UL TCI state indicated to the UE are different from each other, the UE may apply individual beams to uplink transmission and downlink reception, based on the indicated UL TCI state and DL TCI state.

A maximum of 128 joint TCI states may be configured for a particular bandwidth part in a particular cell for the UE by the base station through higher layer signaling, a maximum of 64 or 128 DL TCI states, which are separate TCI states, may be configured for a particular bandwidth part in a particular cell through higher layer signaling, based on a UE capability report, and a DL TCI state among separate TCI states and a joint TCI state may use the same higher layer signaling structure. For example, if 128 joint TCI states are configured and 64 DL TCI states of separate TCI states are configured, the 64 DL TCI states may be included in the 128 joint TCI states.

A maximum of 32 or 64 UL TCI states, which are separate TCI states, may be configured for a particular bandwidth part in a particular cell through higher layer signaling, based on a UE capability report, and a UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

As described above, using different or identical higher layer signaling structures may be defined in a specification, or may be distinguished through another higher layer signaling configured by a base station, based on a UE capability report including information on a usage scheme which a UE is able to support among two types of usage schemes.

A transmission/reception beam-related indication may be received by a UE in a unified TCI scheme by using one scheme among a joint TCI state and a separate TCI state configured by a base station. Whether to use one of a joint TCI state and a separate TCI state may be configured for a UE by a base station through higher layer signaling.

A UE may receive a transmission/reception beam-related indication through higher layer signaling by using one scheme selected from among a joint TCI state and a separate TCI state, and a method of transmission/reception beam-related indication by a base station may be classified as two types of methods including a MAC-CE-based indication method and a MAC-CE-based activation and DCI-based indication method.

In a case where a UE receives a transmission/reception beam-related indication through higher layer signaling by using a joint TCI state scheme, the UE may receive a MAC-CE indicating a joint TCI state from a base station to perform a transmission/reception beam application operation, and the base station may schedule reception of a PDSCH including the MAC-CE to the UE through a PDCCH. If there is one joint TCI state included in a MAC-CE, the UE may determine an uplink transmission beam or transmission filter and a downlink reception beam or reception filter by using the indicated joint TCI state after 3 ms after PUCCH transmission including HARQ-ACK information meaning whether a PDSCH including the MAC-CE has been successfully received. If there are two or more joint TCI states included in a MAC-CE, the UE may identify that multiple joint TCI states indicated by the MAC-CE correspond to respective codepoints of a TCI state field of DCI format 1_1 or 1_2 after 3 ms after PUCCH transmission including HARQ-ACK information meaning whether a PDSCH including the MAC-CE has been successfully received, and activate the indicated joint TCI states. Thereafter, the UE may receive DCI format 1_1 or 1_2 to apply one joint TCI state indicated by a TCI state field in the DCI to uplink transmission and downlink reception beams. DCI format 1_1 or 1_2 may include downlink data channel scheduling information (with DL assignment) or not include same (without DL assignment).

In a case where a UE receives a transmission/reception beam-related indication through higher layer signaling by using a separate TCI state scheme, the UE may receive a MAC-CE indicating a separate TCI state from a base station to perform a transmission/reception beam application operation, and the base station may schedule reception of a PDSCH including the MAC-CE to the UE through a PDCCH. If a MAC-CE includes one separate TCI state set, the UE may determine an uplink transmission beam or transmission filter and a downlink reception beam or reception filter by using separate TCI states included in the indicated separate TCI state set after 3 ms after PUCCH transmission including HARQ-ACK information meaning whether a corresponding PDSCH has been successfully received. A separate TCI state set may indicate a single or multiple separate TCI states which one codepoint of a TCI state field in DCI format 1_1 or 1_2 may have, and one separate TCI state set may include one DL TCI state, include one UL TCI state, or include one DL TCI state and one UL TCI state. If a MAC-CE includes two or more separate TCI state sets, the UE may identify that multiple separate TCI state sets indicated by the MAC-CE correspond to respective codepoints of a TCI state field of DCI format 1_1 or 1_2 after 3 ms after PUCCH transmission including HARQ-ACK information meaning whether a corresponding PDSCH has been successfully received, and may activate the indicated separate TCI state sets. Each codepoint of the TCI state field of DCI format 1_1 or 1_2 may indicate one DL TCI state, indicate one UL TCI state, or indicate one DL TCI state and one UL TCI state. The UE may receive DCI format 1_1 or 1_2 to apply a separate TCI state set indicated by a TCI state field in the DCI to uplink transmission and downlink reception beams. DCI format 1_1 or 1_2 may include downlink data channel scheduling information (with DL assignment) or not include same (without DL assignment).

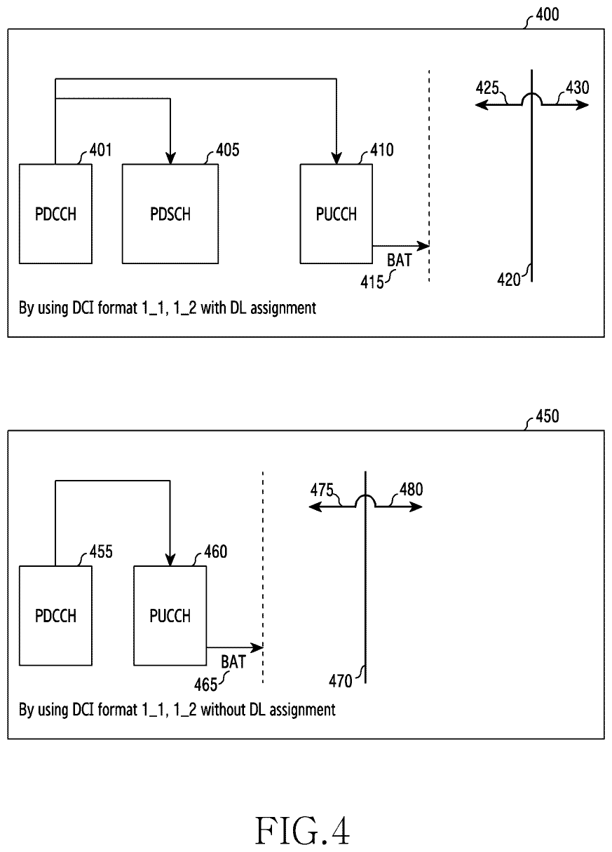

FIG. 4 illustrates a beam application time which may be considered when a unified TCI scheme is used in a wireless communication system according to an embodiment of the disclosure. As described above, a UE may receive, from a base station, DCI format 1_1 or 1_2 including or not including downlink data channel scheduling information (with DL assignment or without DL assignment), and apply one joint TCI state or one separate TCI state set indicated by a TCI state field in the DCI to uplink transmission and downlink reception beams.
DCI format 1_1 or 1_2 with DL assignment (as indicated by reference numeral 400): If a UE receives, from a base station, DCI format 1_1 or 1_2 401 including downlink data channel scheduling information so that one joint TCI state or one separate TCI state set based on a unified TCI scheme is indicated, the UE may receive a PDSCH 405 scheduled based on the received DCI, and transmit a PUCCH 410 including a HARQ-ACK indicating whether reception of the DCI and the PDSCH is successful. The HARQ-ACK may include whether reception is successful, for both the DCI and the PDSCH, if the UE fails to receive at least one of the DCI and the PDSCH, the UE may transmit a NACK, and if the UE succeeds in receiving both of them, the UE may transmit an ACK.
DCI format 1_1 or 1_2 without DL assignment (as indicated by reference numeral 450): If a UE receives, from a base station, DCI format 1_1 or 1_2 455 not including downlink data channel scheduling information so that one joint TCI state or one separate TCI state set based on a unified TCI scheme is indicated, the UE may assume at least one combination of the following items for the DCI.
The DCI includes a CRC scrambled using a CS-RNTI.
The values of all bits assigned to all fields used as redundancy version fields are 1.
The values of all bits assigned to all fields used as modulation and coding scheme (MCS) fields are 1.
The values of all bits assigned to all fields used as new data indication (NDI) fields are 0.
In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit a PUCCH 460 including a HARQ-ACK indicating whether DCI format 1_1 or 1_2 on which the items described above are assumed is successfully received.
With respect to both DCI format 1_1 or 1_2 with DL assignment (as indicated by reference numeral 400) and without DL assignment (as indicated by reference numeral 450), if the new TCI state indicated through DCI 401 or 455 is the same as a TCI state that has previously been indicated and thus been being applied to uplink transmission and downlink reception beams, the UE may maintain the previously applied TCI state. If the new TCI state is different from the previously indicated TCI state, the UE may determine, as a time point for application of the joint TCI state or separate TCI state set, which is indicatable by a TCI state field included in the DCI, a time point 430 or 480 after the first slot 420 or 470 after passage of a time interval as long as a beam application time (BAT) 415 or 465 after PUCCH transmission, and may use the previously indicated TCI state at a time point 425 or 475 before the slot 420 or 470.
With respect to both DCI format 1_1 or 1_2 with DL assignment (as indicated by reference numeral 400) and without DL assignment (as indicated by reference numeral 450), the BAT is a particular number of OFDM symbols and may be configured through higher layer signaling, based on UE capability report information, and numerologies of the BAT and the first slot after the BAT may be determined based on the smallest numerology among all cells to which a joint TCI state or separate TCI state set indicated through DCI is applied.

A UE may apply one joint TCI state indicated through a MAC-CE or DCI to reception for control resource sets connected to all UE-specific particular search spaces, reception of a PDSCH scheduled by a PDCCH transmitted from the control resource sets and transmission of a PUSCH, and transmission of all PUCCH resources.

If one separate TCI state set indicated through a MAC-CE or DCI includes one DL TCI state, a UE may apply the one separate TCI state set to reception for control resource sets connected to all UE-specific particular search spaces and to reception of a PDSCH scheduled by a PDCCH transmitted from the control resource sets, and apply a previously indicated UL TCI state to all PUSCH and PUCCH resources.

If one separate TCI state set indicated through a MAC-CE or DCI includes one UL TCI state, a UE may apply the one separate TCI state set to all PUSCH and PUCCH resources, and apply a previously indicated DL TCI state to reception for control resource sets connected to all UE-specific particular search spaces and reception of a PDSCH scheduled by a PDCCH transmitted from the control resource sets.

If one separate TCI state set indicated through a MAC-CE or DCI includes one DL TCI state and one UL TCI state, a UE may apply the DL TCI state to reception for control resource sets connected to all UE-specific particular search spaces and reception of a PDSCH scheduled by a PDCCH transmitted from the control resource sets, and apply the UL TCI state to all PUSCH and PUCCH resources.

### [Unified TCI State MAC-CE]

Hereinafter, a single TCI state indication and activation method based on a unified TCI scheme is described. A PDSCH including a MAC-CE described below may be scheduled to a UE by a base station, and the UE may interpret each codepoint of a TCI state field in DCI format 1_1 or 1_2, based on information in the MAC-CE received from the base station, after 3 slots from transmission of a HARQ-ACK for the PDSCH to the base station. For example, the UE may activate each entry of the MAC-CE received from the base station in each codepoint of the TCI state field in DCI format 1_1 or 1_2.

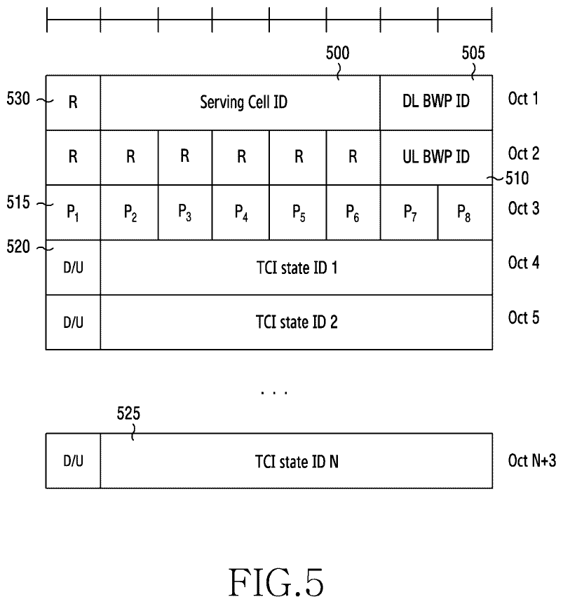

FIG. 5 illustrates another MAC-CE structure for activation and indication of a joint TCI state or a separate DL or UL TCI state in a wireless communication system according to an embodiment of the disclosure. Each field in the MAC-CE structure may have the following meaning.
Serving Cell ID 500: This field may indicate whether a corresponding MAC-CE is to be applied to which serving cell. The length of this field may be 5 bits. If a serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4, in which the serving cell indicated by the field is included.
DL BWP ID 505: This field may indicate whether the MAC-CE is to be applied to which DL BWP, and the meanings of codepoints in the field may correspond to codepoints of a bandwidth part indicator in DCI, respectively. The length of this field may be 2 bits.
UL BWP ID 510: This field may indicate whether the MAC-CE is to be applied to which UL BWP, and the meanings of codepoints in the field may correspond to codepoints of a bandwidth part indicator in DCI, respectively. The length of this field may be 2 bits.
Pᵢ 515: This field may indicate whether each codepoint of a TCI state field in DCI format 1_1 or 1_2 has multiple TCI states or one TCI state. If a value of Pᵢ is 1, this indicates that a corresponding i-th codepoint has multiple TCI states, and may imply that the codepoint may include a separate DL TCI state and a separate UL TCI state. If a value of Pᵢ is 0, this indicates that a corresponding i-th codepoint has a single TCI state, and may imply that the codepoint may include one of a joint TCI state, a separate DCI TCI state, or a separate UL TCI state.
D/U 520: This field may indicate whether a TCI state ID field in the same octet is a joint TCI state, a separate DL TCI state, or a separate UL TCI state. If the field is 1, a TCI state ID field in the same octet may be a joint TCI state or a separate DL TCI state, and if the field is 0, a TCI state ID field in the same octet may be a separate UL TCI state.
TCI state ID 525: This field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in a case of joint TCI states, and may be 16 in a case of separate DL or UL TCI states.
R: This indicates a reserved bit and may be configured to be 0.

With respect to the MAC-CE structure of FIG. 5, a UE may include, in the MAC-CE structure, a third octet including P1, P2, . . . , and P8 fields in FIG. 5 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. As another example, with respect to the MAC-CE structure of FIG. 5, a UE may omit the third octet including P1, P2, . . . , and P8 fields, as illustrated in FIG. 5, in a case where unifiedTCI-StateType-r17 in MIMOparam-r17 in the higher layer signaling ServingCellConfig being configured to be joint. In this case, the UE may save the payload of the MAC-CE structure by a maximum of 8 bits according to higher layer signaling configured by a base station. In addition, all D/U fields positioned on the first bits in octets starting from a fourth octet in FIG. 5 may be considered as R fields, and all the R fields may be configured to be 0 bits.

### [CSI Resource Configuration]

NR has a CSI framework for indicating, by a base station, measurement and reporting of channel state information (CSI) to a UE. The CSI framework of NR may be configured by at least two elements including a resource setting and a report setting. A report setting may have a connection relationship with a resource setting by referring to at least one ID of the resource setting.

According to an embodiment, a resource setting may include information related to a reference signal (RS) for measuring channel state information by a UE. A base station may configure at least one resource setting for a UE. For example, the base station and the UE may exchange signaling information as shown in [Table 4] to transfer information on a resource setting.

TABLE 4

```
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
    nzp-CSI-RS-SSB SEQUENCE {
      nzp-CSI-RS-ResourceSetList SEQUENCE (SIZE (1..maxNrofNZP-CSI-RS-
ResourceSetsPerConfig)) OF NZP-CSI-RS-ResourceSetId
                                                          OPTIONAL, -- Need R
      csi-SSB-ResourceSetList SEQUENCE (SIZE (1..maxNrofCSI-SSB-
ResourceSetsPerConfig)) OF CSI-SSB-ResourceSetId
                                                          OPTIONAL -- Need R
    },
    csi-IM-ResourceSetList SEQUENCE (SIZE (1..maxNrofCSI-IM-
ResourceSetsPerConfig)) OF CSI-IM-ResourceSetId
  },
  bwp-Id BWP-Id,
  resourceType ENUMERATED { aperiodic, semiPersistent, periodic },
  ...
}
-- TAG-CSI-RESOURCECONFIG-STOP
-- ASN1STOP
```

The signaling information CSI-ResourceConfig in [Table 4] includes information on each resource setting. According to the signaling information, each resource setting may include a resource setting index (csi-ResourceConfigId), a BWP index (bwp-ID), time axis transmission configuration of resources (resourceType), or a resource set list (csi-RS-ResourceSetList) including at least one resource set. Time domain transmission configuration of resources may be configured to be aperiodic transmission, semi-persistent transmission, or periodic transmission. A resource set list may be a set including resource sets for channel measurement, or a set including resource sets for interference measurement. If a resource set list is a set including resource sets for channel measurement, each resource set may include at least one resource, and the at least one resource may correspond to an index of a CSI reference signal (CSI-RS) resource or a synchronization/broadcast channel block (SS/PBCH block, SSB). If a resource set list is a set including resource sets for interference measurement, each resource set may include at least one interference measurement resource (CSI interference measurement, CSI-IM).

For example, if a resource set includes a CSI-RS, a base station and a UE may exchange signaling information as shown in [Table 5] to transfer information on the resource set.

TABLE 5

```
-- ASN1START
-- TAG-NZP-CSI-RS-RESOURCESET-START
NZP-CSI-RS-ResourceSet ::= SEQUENCE {
  nzp-CSI-ResourceSetId NZP-CSI-RS-ResourceSetId,
  nzp-CSI-RS-Resources SEQUENCE (SIZE (1..maxNrofNZP-CSI-RS-
ResourcesPerSet)) OF NZP-CSI-RS-ResourceId,
  repetition ENUMERATED { on, off } OPTIONAL,
-- Need S
  aperiodicTriggeringOffset INTEGER(0..6) OPTIONAL,
-- Need S
  trs-Info ENUMERATED {true } OPTIONAL,
-- Need R
  ...
}
-- TAG-NZP-CSI-RS-RESOURCESET-STOP
-- ASN1STOP
```

The signaling information NZP-CSI-RS-ResourceSet in [Table 5] includes information on each resource set. According to the signaling information, each resource set may include at least information on a resource set index (nzp-CSI-ResourceSetId) or a set (nzp-CSI-RS-Resources) of CSI-RS indexes included therein. Further, each resource set may include some of information (repetition) on a spatial domain transmission filter of CSI-RS resources included therein, and/or information (trs-Info) relating to whether CSI-RS resources included therein have a tracking purpose.

A CSI-RS may be the most representative reference signal included in a resource set. A base station and a UE may exchange signaling information as shown in [Table 6] to transfer information on a CSI-RS resource.

TABLE 6

```
-- ASN1START
-- TAG-NZP-CSI-RS-RESOURCE-START
NZP-CSI-RS-Resource ::= SEQUENCE {
  nzp-CSI-RS-ResourceId NZP-CSI-RS-ResourceId,
  resourceMapping CSI-RS-ResourceMapping,
  powerControlOffset INTEGER (−8..15),
  powerControlOffsetSS ENUMERATED{db-3, db0, db3, db6} OPTIONAL,
-- Need R
  scramblingID ScramblingId,
  periodicityAndOffset CSI-ResourcePeriodicityAndOffset OPTIONAL, -
- Cond PeriodicOrSemiPersistent
  qcl-InfoPeriodicCSI-RS TCI-StateId OPTIONAL, -- Cond
Periodic
  ...
}
-- TAG-NZP-CSI-RS-RESOURCE-STOP
-- ASN1STOP
```

The signaling information NZP-CSI-RS-Resource in [Table 6] may include information on each CSI-RS. The information included in the signaling information NZP-CSI-RS-Resource may have meanings as below:
nzp-CSI-RS-ResourceId: The index of a CSI-RS resource;
resourceMapping: Resource mapping information of a CSI-RS resource;
powerControlOffset: The ratio between PDSCH EPRE (Energy Per RE) and CSI-RS EPRE;
powerControlOffsetSS: The ratio between SS/PBCH block EPRE and CSI-RS EPRE;
scramblingID: The scrambling index of a CSI-RS sequence;
periodicity AndOffset: The transmission period and the slot offset of a CSI-RS resource; and/or
qcl-InfoPeriodicCSI-RS: TCI-state information when a CSI-RS is a periodic CSI-RS.

“resourceMapping” included in the signaling information NZP-CSI-RS-Resource may indicate resource mapping information of a CSI-RS resource, and the resource mapping information may include resource element (RE) mapping for frequency resources, the number of ports, symbol mapping, CDM type, frequency resource density, and frequency band mapping information. Each of the number of ports, frequency resource density, CDM type, and time-frequency axis RE mapping, which may be configured through the signaling information, may have a predetermined value in one of the rows shown in [Table 7] below.

TABLE 7

| | Ports | Density | | | CDM | | |
|---|---|---|---|---|---|---|---|
| Row | X | ρ | cdm-Type | (k̅, l̅) | group index j | k′ | l′ |
| 1 | 1 | 3 | No CDM | (k₀, l₀), (k₀ + 4, l₀), (k₀ + 8, l₀) | 0, 0, 0 | 0 | 0 |
| 2 | 1 | 1, 0.5 | No CDM | (k₀, l₀) | 0 | 0 | 0 |
| 3 | 2 | 1, 0.5 | FD- | (k₀, l₀) | 0 | 0, 1 | 0 |
| | | | CDM2 | | | | |
| 4 | 4 | 1 | FD- | (k₀, l₀), (k₀ + 2, l₀) | 0, 1 | 0, 1 | 0 |
| | | | CDM2 | | | | |
| 5 | 4 | 1 | FD- | (k₀, l₀), (k₀, l₀ + 1) | 0, 1 | 0, 1 | 0 |
| | | | CDM2 | | | | |
| 6 | 8 | 1 | FD- | (k₀, l₀), (k₁, l₀), (k₂, l₀), (k₃, l₀) | 0, 1, 2, 3 | 0, 1 | 0 |
| | | | CDM2 | | | | |
| 7 | 8 | 1 | FD- | (k₀, l₀), (k₁, l₀), (k₀, l₀ + 1), (k₁, l₀ + | 0, 1, 2, 3 | 0, 1 | 0 |
| | | | CDM2 | 1) | | | |
| 8 | 8 | 1 | CDM4 | (k₀, l₀), (k₁, l₀) | 0, 1 | 0, 1 | 0, 1 |
| | | | (FD2, TD | | | | |
| | | | 2) | | | | |
| 9 | 12 | 1 | FD- | (k₀, l₀) , (k₁, l₀) , (k₂, l₀) , (k₃, l₀) | 0, 1, 2, 3, | 0, 1 | 0 |
| | | | CDM2 | (k₄, l₀), (k₅, l₀) | 4, 5 | | |
| 10 | 12 | 1 | CDM4 | (k₀, l₀), (k₁, l₀), (k₂, l₀) | 0, 1, 2 | 0, 1 | 0, 1 |
| | | | (FD2, TD | | | | |
| | | | 2) | | | | |
| 11 | 16 | 1, 0.5 | FD- | (K₀, l₀) , (k₁, l₀) , (k₂, l₀) , (k₃, l₀), | 0, 1, 2, 3, | 0, 1 | 0 |
| | | | CDM2 | (k₀, l₀ + 1), (k₁, l₀ + 1), (k₂, l₀ + 1), | 4, 5, 6, 7 | | |
| | | | | (k₃, l₀ + 1) | | | |
| 12 | 16 | 1, 0.5 | CDM4 | (k₀, l₀), (k₁, l₀), (k₂, l₀), (k₃, l₀) | 0, 1, 2, 3 | 0, 1 | 0, 1 |
| | | | (FD2, TD | | | | |
| | | | 2) | | | | |
| 13 | 24 | 1, 0.5 | FD- | (k₀, l₀), (k₁, l₀), (k₂, l₀), (k₀, l₀ + 1), | 0, 1, 2, 3, | 0, 1 | 0 |
| | | | CDM2 | (k1, l₀ + 1) , (k₂, l₀ + 1) , (k₀, l₁) | 6, 4, 5, | | |
| | | | | (k₁, l₁), (k₂, l₁), (k₀, l₁ + 1), (k₁, l₁ + | 6, 7, 8, 9 10, 11 | | |
| | | | | 1), (k₂, l₁ + 1) | | | |
| 14 | 24 | 1, 0.5 | CDM4 | (k₀, l₀) , (k₁, l₀) , (k₂, l₀) , (k₀, l₁), | 0, 1, 2, 3, | 0, 1 | 0, 1 |
| | | | (FD2, TD | (k₁, l₁), (k₂, l₁) | 4, 5 | | |
| | | | 2) | | | | |
| 15 | 24 | 1, 0.5 | CDM8 | (k₀, l₀), (k₁, l₀), (k₂, l₀) | 0, 1, 2 | 0, 1 | 0, 1, 2, 3 |
| | | | FD2, TD | | | | |
| | | | 4) | | | | |
| 16 | 32 | 1, 0.5 | FD- | (k₀, l₀) , (k₁, l₀) , (k₂, l₀) , (k₃, 1₀), | 0, 1, 2, 3, | 0, 1 | 0 |
| | | | CDM2 | (k₀, l₀ + 1), (k₁, l₀ + 1), (k₂, l₀ + 1), | 4, 5, 6, 7, | | |
| | | | | (k₃, l₀ + 1), (k₀, 1₁), (k₁, l₁), (k₂, l₁), | 8, 9, 10, 11, | | |
| | | | | (k₃, l₁), (k₀, l₁ + 1), (k₁, l₁ + 1), | 12, 13, | | |
| | | | | (k₂, l₁ + 1), (k₃, l₁ + 1) | 14, 15 | | |
| 17 | 32 | 1, 0.5 | CDM4 | (k₀, l₀) , (k₁, l₀) , (k₂, l₀) , (k₃, l₀) | 0, 1, 2, 3, | 0, 1 | 0, 1 |
| | | | (FD2, TD | (k₀, l₁), (k₁, l₁), (k₂, l₁), (k₃, l₁) | 4, 5, 6, 7 | | |
| | | | 2) | | | | |
| 18 | 32 | 1, 0.5 | CDM8 | (k₀, l₀), (k₁, l₀), (k₂, l₀), (k₃, l₀) | 0, 1, 2, 3 | 0, 1 | 0, 1, 2, 3 |
| | | | (FD2, TD | | | | |
| | | | 4) | | | | |

[Table 7] shows a frequency resource density configurable according to the number (X) of CSI-RS ports, a CDM type, frequency and time domain starting positions (k̅, l̅) of a CSI-RS component RE pattern, and the number (k′) of frequency domain REs and the number (l′) of time domain REs of a CSI-RS component RE pattern. A CSI-RS component RE pattern described above may be a basic unit for configuring a CSI-RS resource. A CSI-RS component RE pattern may be configured by YZ number of REs through Y=1+max (k′) number of REs at the frequency axis and Z=1+max (l′) number of REs at the time axis. If the number of CSI-RS ports is 1, the position of a CSI-RS RE may be designated in a physical resource block (PRB) without restriction on subcarriers, and may be designated by a bitmap having 12 bits. If the number of CSI-RS ports is {2, 4, 8, 12, 16, 24, 32}, and Y is equal to 2, the position of a CSI-RS RE may be designated at every two subcarriers in a PRB, and may be designated by a bitmap having 6 bits. If the number of CSI-RS ports is 4, and Y is equal to 4, the position of a CSI-RS RE may be designated at every four subcarriers in a PRB, and may be designated by a bitmap having 3 bits. Similarly, the position of a time axis RE may be designated by a bitmap having a total of 14 bits.

### [CSI Resource Configuration]

According to an embodiment of the disclosure, a report setting may refer to IDs of one or more resource settings to have a connection relation with the resource settings, and the resource setting(s) having a connection with the report setting provides configuration information including information on a reference signal for channel information measurement. In a case where a resource setting(s) having a connection relation with a report setting is used for channel information measurement, measured channel information may be used for channel information reporting following a reporting method configured in the report setting having the connection relation.

According to an embodiment of the disclosure, a report setting may include configuration information related to a CSI reporting method. For example, the base station and the UE may exchange signaling information as shown in [Table 8] to transfer information on a report setting.

TABLE 8

```
-- ASN1START
-- TAG-CSI-REPORTCONFIG-START
CSI-ReportConfig ::= SEQUENCE {
  reportConfigId CSI-ReportConfigId,
  carrier ServCellIndex OPTIONAL, -- Need S
  resourcesForChannelMeasurement CSI-ResourceConfigId,
  csi-IM-ResourcesForInterference CSI-ResourceConfigId OPTIONAL, -- Need
R
  nzp-CSI-RS-ResourcesForInterference CSI-ResourceConfigId OPTIONAL, --
Need R
  reportConfigType CHOICE {
    periodic SEQUENCE {
      reportSlotConfig CSI-ReportPeriodicityAndOffset,
      pucch-CSI-ResourceList SEQUENCE (SIZE (1..maxNrofBWPs)) OF PUCCH-
CSI-Resource
    },
    semiPersistentOnPUCCH SEQUENCE {
      reportSlotConfig CSI-ReportPeriodicityAndOffset,
      pucch-CSI-ResourceList SEQUENCE (SIZE (1..maxNrofBWPs)) OF PUCCH-
CSI-Resource
    },
    semiPersistentOnPUSCH SEQUENCE {
      reportSlotConfig ENUMERATED {sl5, sl10, sl20, sl40, sl80, sl160,
sl320},
      reportSlotOffsetList SEQUENCE (SIZE (1..maxNrofUL-Allocations)) OF
INTEGER(0..32),
      p0alpha P0-PUSCH-AlphaSetId
    },
    aperiodic SEQUENCE {
      reportSlotOffsetList SEQUENCE (SIZE (1..maxNrofUL-Allocations)) OF
INTEGER(0..32)
    }
  },
  reportQuantity CHOICE {
    none NULL,
    cri-RI-PMI-CQI NULL,
    cri-RI-i1 NULL,
    cri-RI-i1-CQI SEQUENCE {
      pdsch-BundleSizeForCSI ENUMERATED {n2, n4}
OPTIONAL -- Need S
    },
    cri-RI-CQI NULL,
    cri-RSRP NULL,
    ssb-Index-RSRP NULL,
    cri-RI-LI-PMI-CQI NULL
  },
  reportFreqConfiguration SEQUENCE {
    cqi-FormatIndicator ENUMERATED { widebandCQI, subbandCQI }
OPTIONAL, -- Need R
    pmi-FormatIndicator ENUMERATED { widebandPMI, subbandPMI }
OPTIONAL, -- Need R
    csi-ReportingBand CHOICE {
      subbands3 BIT STRING(SIZE(3)),
      subbands4 BIT STRING(SIZE(4)),
      subbands5 BIT STRING(SIZE(5)),
      subbands6 BIT STRING(SIZE(6)),
      subbands7 BIT STRING(SIZE(7)),
      subbands8 BIT STRING(SIZE(8)),
      subbands9 BIT STRING(SIZE(9)),
      subbands10 BIT STRING(SIZE(10)),
      subbands11 BIT STRING(SIZE(11)),
      subbands12 BIT STRING(SIZE(12)),
      subbands13 BIT STRING(SIZE(13)),
      subbands14 BIT STRING(SIZE(14)),
      subbands15 BIT STRING(SIZE(15)),
      subbands16 BIT STRING(SIZE(16)),
      subbands17 BIT STRING(SIZE(17)),
      subbands18 BIT STRING(SIZE(18)),
      ...,
      subbands19-v1530 BIT STRING(SIZE(19))
    } OPTIONAL -- Need S
  }
  timeRestrictionForChannelMeasurements ENUMERATED {configured,
notConfigured },
  timeRestrictionForInterferenceMeasurements ENUMERATED {configured,
notConfigured},
  codebookConfig CodebookConfig OPTIONAL,
-- Need R
  dummy ENUMERATED {n1, n2} OPTIONAL,
-- Need R
  groupBasedBeamReporting CHOICE {
    enabled NULL,
    disabled SEQUENCE {
      nrofReportedRS ENUMERATED {n1, n2, n3, n4}
OPTIONAL -- Need S
    }
  },
  cqi-Table ENUMERATED {table1, table2, table3, spare1 }
OPTIONAL, -- Need R
  subbandSize ENUMERATED { value1, value2},
  non-PMI-PortIndication SEQUENCE (SIZE (1..maxNrofNZP-CSI-RS-
ResourcesPerConfig)) OF PortIndexFor8Ranks OPTIONAL, -- Need R
  ...,
  [[
  semiPersistentOnPUSCH-v1530 SEQUENCE {
    reportSlotConfig-v1530 ENUMERATED {sl4, sl8, sl16}
  } OPTIONAL -- Need R
  ]]
}
```

The signaling information CSI-ReportConfig in [Table 8] includes information on each report setting. The information included in the signaling information CSI-ReportConfig may have meanings as below:
reportConfigId: The index of a report setting;
carrier: The index of a serving cell;
resourcesForChannelMeasurement: the index of a resource setting for a channel measurement having a connection relation with a report setting;
csi-IM-ResourcesForInterference: the index of a resource setting having a CSI-IM resource for interference measurement having a connection relation with a report setting;
nzp-CSI-RS-ResourcesForInterference: the index of a resource setting having a CSI-RS resource for interference measurement having a connection relation with a report setting;
reportConfigType: this indicates a time axis transmission configuration and a transmission channel of channel reporting, and may have an aperiodic transmission, semi-persistent physical uplink control channel (PUCCH) transmission, semi-persistent physical uplink shared channel (PUSCH) transmission, or periodic transmission configuration;
reportQuantity: this represents the type of reported channel information and may have the types of channel information when a channel report is not transmitted (“none”) and when a channel report is transmitted (“cri-RI-PMI-CQI,” “cri-RI-i1,” “cri-RI-i1-CQI,” “cri-RI-CQI,” “cri-RSRP,” “ssb-Index-RSRP,” and “cri-RI-LI-PMI-CQI”). Elements included in the types of channel information indicate a channel quality indicator (CQI), a precoding matrix indicator (PMI), a CSI-RS resource indicator (CRI), an SS/PBCH block resource indicator (SSBRI), a layer indicator (LI), a rank indicator (RI), and/or a reference signal received power (L1-RSRP);
reportFreqConfiguration: this indicates that reported channel information includes only information on the entire band (wideband) or information on each subband, and if the reported channel information includes information on each subband, this may have configuration information on the subband including channel information;
timeRestrictionForChannelMeasurements: whether there is a restriction on the time axis for a reference signal for channel measurement among reference signals referred to by reported channel information;
timeRestrictionForInterferenceMeasurements: whether there is a restriction on the time axis for a reference signal for interference measurement among reference signals referred to by reported channel information;
codebookConfig: information on a codebook referred to by reported channel information;
groupBasedBeamReporting: whether beam grouping is applied for channel reporting;
cqi-Table: the index of a CQI table referred to by reported channel information;
subbandSize: an index indicating a subband size of channel information; and/or
non-PMI-PortIndication: port mapping information referred to when non-PMI channel information is reported.

In a case where a base station indicates channel information reporting through higher layer signaling or L1 signaling, a UE may perform channel information reporting by referring to configuration information described above included in an indicated report setting.

A base station may indicate, to a UE, channel state information (CSI) reporting through higher layer signaling including radio resource control (RRC) signaling or medium access control (MAC)-control element (CE) signaling or L1 signaling (e.g., common DCI, group-common DCI, or UE-specific DCI).

For example, a base station may indicate aperiodic channel information reporting (CSI report) to a UE through higher layer signaling or DCI using DCI format 0_1. The base station configures, through higher layer signaling, a parameter for an aperiodic CSI report of a UE or multiple CSI report trigger states including a parameter for a CSI report. A parameter for a CSI report or a CSI report trigger state may include a slot interval between a PDCCH including DCI and a PUSCH including the CSI report or a set including possible slot intervals, a reference signal ID for channel state measurement, or the type of channel information included therein. When a base station indicates some of multiple CSI report trigger states to a UE through DCI, the UE reports channel information according to a CSI report configuration of a report setting configured in the indicated CSI report trigger states. The channel information reporting may be performed through a PUSCH scheduled by DCI format 0_1. Time axis resource allocation of a PUSCH including a CSI report of the UE may be performed through a slot interval from a PDCCH indicated through DCI, and an indication of a starting symbol and a symbol length in a slot for time axis resource allocation of the PUSCH. For example, it is possible to indicate the position of a slot on which a PUSCH including a CSI report of a UE is transmitted, through a slot interval from a PDCCH indicated through DCI, and indicate a starting symbol and a symbol length in the slot through a time domain resource assignment field of the DCI.

For example, a base station may indicate a semi-persistent CSI report transmitted through a PUSCH to a UE, through DCI using DCI format 0_1. The base station may activate or deactivate a semi-persistent CSI report transmitted through a PUSCH, through DCI scrambled by an SP-CSI-RNTI. If a semi-persistent CSI report is activated, a UE may periodically report channel information according to a configured slot interval. If the semi-persistent CSI report is deactivated, the UE may stop periodic channel information reporting having been activated. A base station configures, through higher layer signaling, a parameter for a semi-persistent CSI report of the UE or multiple CSI report trigger states including a parameter for a semi-persistent CSI report. A parameter for a CSI report or a CSI report trigger state may include a slot interval between a PDCCH including DCI indicating the CSI report and a PUSCH including the CSI report or a set including possible slot intervals, a slot interval between a slot on which higher layer signaling indicating the CSI report is activated and the PUSCH including the CSI report, a slot interval period of the CSI report, or the type of channel information included therein. If a base station activates some of multiple CSI report trigger states or some of multiple report settings for a UE through higher layer signaling or DCI, the UE may report channel information according to a CSI report configuration configured in a report setting included in the indicated CSI report trigger states or the activated report settings. The channel information reporting may be performed through a PUSCH semi-persistently scheduled by DCI format 0_1 scrambled by an SP-CSI-RNTI. Time axis resource allocation of a PUSCH including a CSI report of the UE may be performed through a slot interval period of the CSI report, a slot interval from a slot on which higher layer signaling is activated, or a slot interval from a PDCCH indicated through DCI, or an indication of a starting symbol and a symbol length in a slot for time axis resource allocation of the PUSCH. For example, it is possible to indicate the position of a slot on which a PUSCH including a CSI report of the UE is transmitted, through a slot interval from a PDCCH indicated through DCI, and indicate a starting symbol and symbol length in the slot through a time domain resource assignment field of DCI format 0_1 described above.

For example, a base station may indicate a semi-persistent CSI report transmitted through a PUCCH to a UE, through higher layer signaling such as a MAC-CE. The base station may activate or deactivate a semi-persistent CSI report transmitted through a PUCCH, through the MAC-CE signaling. If a semi-persistent CSI report is activated, a UE may periodically report channel information according to a configured slot interval. If the semi-persistent CSI report is deactivated, the UE may stop periodic channel information reporting having been activated. A base station configures a parameter for a semi-persistent CSI report of the UE through higher layer signaling. The parameter for a CSI report may include a PUCCH resource on which the CSI report is transmitted, a slot interval period of the CSI report, or the type of channel information included therein. The UE may transmit the CSI report through a PUCCH. Alternatively, in a case where a PUCCH for a CSI report overlaps with a PUSCH, the UE may transmit the CSI report through the PUSCH. It is possible to indicate the position of a PUCCH transmission slot including the CSI report through a slot interval period of the CSI report configured through higher layer signaling, or a slot interval between a slot on which higher layer signaling is activated and the PUCCH including the CSI report, and indicate a starting symbol and a symbol length in the slot through a starting symbol and a symbol length for which a PUCCH resource configured through higher layer signaling is allocated.

For example, a base station may indicate a periodic CSI report to a UE through higher layer signaling. The base station may activate or deactivate a periodic CSI report through higher layer signaling including RRC signaling. If a periodic CSI report is activated, a UE may periodically report channel information according to a configured slot interval. If the periodic CSI report is deactivated, the UE may stop periodic channel information reporting having been activated. The base station configures a report setting including a parameter for a periodic CSI report of the UE through higher layer signaling. A parameter for a CSI report may include a PUCCH resource configuration for the CSI report, a slot interval between a slot on which higher layer signaling indicating the CSI report is activated and a PUCCH including the CSI report, a slot interval period of the CSI report, a reference signal ID for channel state measurement, or the type of channel information included therein. The UE may transmit the CSI report through a PUCCH. Alternatively, in a case where a PUCCH for a CSI report overlaps with a PUSCH, the UE may transmit the CSI report through the PUSCH. It is possible to indicate the position of a slot on which a PUCCH including the CSI report is transmitted, through a slot interval period of the CSI report configured through higher layer signaling, or a slot interval between a slot on which higher layer signaling is activated and the PUCCH including the CSI report, and indicate a starting symbol and a symbol length in the slot through a starting symbol and a symbol length for which a PUCCH resource configured through higher layer signaling is allocated.

With respect to the above CSI reporting setting (CSI-ReportConfig), each reporting setting (CSI-ReportConfig) may be associated with a downlink (DL) bandwidth part identified by a higher layer parameter bandwidth part identifier (bwp-id) and given by a CSI resource setting (CSI-ResourceConfig) associated with each reporting setting. As a time domain reporting operation for each reporting setting (CSI-ReportConfig), “aperiodic,” “semi-persistent,” and “periodic” types may be supported, and the types may be configured for a UE by a base station through a reportConfigType parameter configured from a higher layer. A semi-persistent CSI reporting method supports “PUCCH-based semi-persistent (semi-PersistentOnPUCCH),” and “PUSCH-based semi-persistent (semi-PersistentOnPUSCH).” In a periodic or semi-persistent CSI reporting method, PUCCH or PUSCH resources on which CSI is to be transmitted may be configured for a UE by a base station through higher layer signaling. The period and slot offset of PUCCH or PUSCH resources on which CSI is to be transmitted may be given by the numerology of an uplink (UL) bandwidth part configured to transmit a CSI report. In an aperiodic CSI reporting method, PUSCH resources on which CSI is to be transmitted may be scheduled for the UE by the base station through L1 signaling (DCI format 0_1 described above).

With respect to a CSI resource setting (CSI-ResourceConfig) described above, each CSI resource setting CSI-ReportConfig may include S (≥1) number of CSI resource sets (given by the higher layer parameter csi-RS-ResourceSetList). A CSI resource set list may include a non-zero power (NZP) CSI-RS resource set and a SS/PBCH block set, or may include a CSI-interference measurement (CSI-IM) resource set. Each CSI resource setting may be positioned in a downlink (DL) bandwidth part identified by a higher layer parameter, bwp-id, and may be connected to a CSI reporting setting in the same downlink bandwidth part. A time domain operation of CSI-RS resources in a CSI resource setting may be configured to one of “aperiodic,” “periodic,” or “semi-persistent” by a higher layer parameter, resourceType. With respect to a periodic or semi-persistent CSI resource setting, the number of CSI-RS resource sets may be limited to S=1, and a configured period and slot offset may be given by the numerology of a downlink bandwidth part identified by a bwp-id. One or more CSI resource settings for channel or interference measurement may be configured for a UE by a base station through higher layer signaling, and for example, the settings may include CSI resources as below:
CSI-IM resource for interference measurement;
NZP CSI-RS resource for interference measurement; and/or
NZP CSI-RS resource for channel measurement.

With respect to CSI-RS resource sets associated with a resource setting having the higher layer parameter resourceType, configured to be “aperiodic,” “periodic,” or “semi-persistent,” the trigger state of a CSI report setting having reportType configured to be “aperiodic,” and a resource setting for channel or interference measurement on one or multiple component cells (CCs) may be configured by the higher layer parameter CSI-AperiodicTriggerStateList.

A UE may use a PUSCH for aperiodic CSI reporting, may use a PUCCH for periodic CSI reporting, and may perform semi-persistent CSI reporting by using a PUSCH when the reporting is triggered or activated by DCI, and using a PUCCH after the reporting is activated by an MAC control element (MAC CE). As described above, a CSI resource setting may be also configured to be aperiodic, periodic, and semi-persistent. A combination of a CSI reporting setting and a CSI resource configuration may be supported based on [Table 9] below.

[Table 9] describes a Triggering/Activation of CSI reporting for the possible CSI-RS Configurations.

TABLE 9

| CSI-RS | | Semi-Persistent | Aperiodic CSI |
|---|---|---|---|
| Configuration | Periodic CSI Reporting | CSI Reporting | Reporting |
| Periodic CSI-RS | No dynamic | For reporting on | Triggered by DCI; |
| | triggering/activation | PUCCH, the UE | additionally, |
| | | receives an | activation command |
| | | activation | [10, TS 38.321] |
| | | command [10, TS | possible as defined |
| | | 38.321]; for | in Subclause |
| | | reporting on | 5.2.1.5.1. |
| | | PUSCH, the UE | |
| | | receives triggering | |
| | | on DCI | |
| Semi-Persistent CSI- | Not Supported | For reporting on | Triggered by DCI; |
| RS | | PUCCH, the UE | additionally, |
| | | receives an | activation command |
| | | activation | [10, TS 38.321] |
| | | command [10, TS | possible as defined |
| | | 38.321]; for | in Subclause |
| | | reporting on | 5.2.1.5.1. |
| | | PUSCH, the UE | |
| | | receives triggering | |
| | | on DCI | |
| Aperiodic CSI-RS | Not Supported | Not Supported | Triggered by DCI; |
| | | | additionally, |
| | | | activation command |
| | | | [10, TS 38.321] |
| | | | possible as defined |
| | | | in Subclause |
| | | | 5.2.1.5.1. |

Aperiodic CSI reporting may be triggered by a “CSI request” field in DCI format 0_1 described above, corresponding to scheduling DCI of a PUSCH. A UE may monitor a PDCCH, obtain DCI format 0_1, and obtain scheduling information for a PUSCH and a CSI request indicator. A CSI request indicator may be configured to have NTS (=0, 1, 2, 3, 4, 5, or 6) number of bits, and may be determined by higher layer signaling (reportTriggerSize). One trigger state among one or multiple aperiodic CSI reporting trigger states which may be configured by higher layer signaling (CSI-AperiodicTriggerStateList), may be triggered by a CSI request indicator.
If all bits in a CSI request field are 0, this may imply that CSI reporting is not requested.
If the number (M) of CSI trigger states in configured CSI-AperiodicTriggerStateList is greater than 2NTs-1, M number of CSI trigger states may be mapped to 2NTs-1 trigger states according to a pre-defined mapping relation, and one trigger state among the 2NTs-1 trigger states may be indicated by a CSI request field.
If the number (M) of configured CSI trigger states in a CSI-AperiodicTriggerStateList is smaller than or equal to 2NTs-1, one of M number of CSI trigger states may be indicated by a CSI request field.

[Table 10] below shows an example of a relation between a CSI request indicator and a CSI trigger state indicatable by the indicator.

TABLE 10

| CSI | | | |
|---|---|---|---|
| request | | CSI- | CSI- |
| field | CSI trigger state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

A UE may measure a CSI resource in a CSI trigger state triggered by a CSI request field, and then generate CSI (including at least one of CQI, PMI, CRI, SSBRI, LI, RI, or L1-RSRP described above) therefrom. The UE may transmit obtained CSI by using a PUSCH scheduled by a corresponding DCI format 0_1. In case that one bit corresponding to an uplink data indicator (UL-SCH indicator) in the DCI format 0_1 indicates “1,” the UE may perform multiplexing of the obtained CSI and uplink data (UL-SCH) with PUSCH resources scheduled by the DCI format 0_1, to transmit the CSI. If one bit corresponding to an uplink data indicator (UL-SCH indicator) in the DCI format 0_1 indicates “0,” the UE may map only the CSI to PUSCH resources scheduled by the DCI format 0_1 without uplink data (UL-SCH), to transmit the CSI.

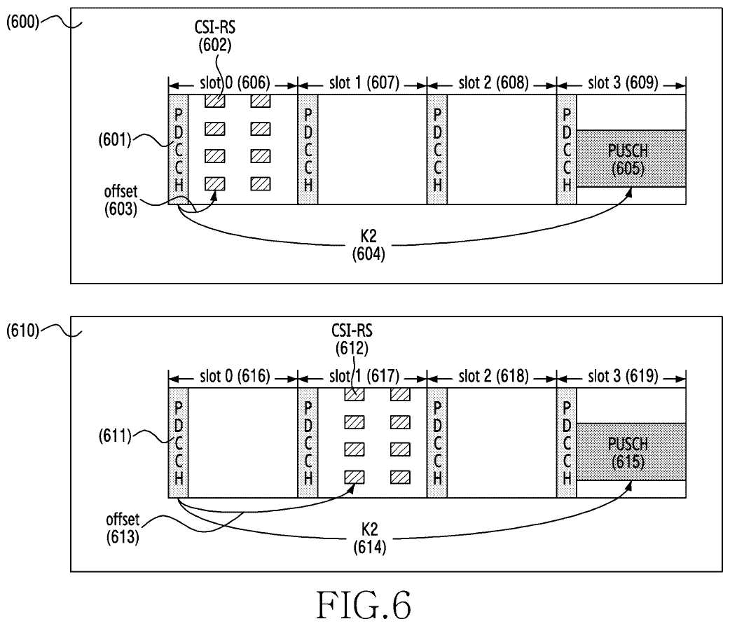

FIG. 6 illustrates an example of an aperiodic CSI reporting method according to an embodiment of the disclosure.

In an example 600 in FIG. 6, a UE may obtain a DCI format 0_1 by monitoring a PDCCH 601, and obtain scheduling information of a PUSCH 605 and CSI request information from the DCI format 0_1. The UE may obtain resource information of a CSI-RS 602 to be measured, from a received CSI request indicator. The UE may determine a time point at which the UE may measure a resource of the CSI-RS 602 transmitted, the determining being based on a time point at which the DCI format 0_1 is received, and an offset-related parameter (aperiodic TriggeringOffset described above) in a CSI resource set configuration (e.g., NZP CSI-RS resource set configuration (NZP-CSI-RS-ResourceSet)). More specifically, the UE may receive an offset value X of the parameter aperiodicTriggeringOffset in an NZP-CSI-RS resource set configuration from a base station by higher layer signaling, and the configured offset value X may be an offset between a slot on which DCI triggering aperiodic CSI reporting is received, and a slot on which a CSI-RS resource is transmitted. For example, the value of an aperiodicTriggeringOffset parameter and an offset value X may have a mapping relation therebetween as shown in table 11 below.

TABLE 11

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

In the example 600 in FIG. 6, an offset value X as described above is configured to be 0. A UE may receive a CSI-RS 602 in a slot (corresponding to slot 0 606 in FIG. 6) having received a DCI format 0_1 triggering aperiodic CSI reporting, and may report CSI information measured by the received CSI-RS, through a PUSCH 605 to the base station. The UE may obtain scheduling information (the above described pieces of information corresponding to individual fields of DCI format 0_1) of the PUSCH 605 for CSI reporting from the DCI format 0_1. For example, the UE may obtain information relating to a slot in which the PUSCH 605 is to be transmitted, from time domain resource allocation information of the PUSCH 605, as described above, in the DCI format 0_1. In the example 600 in FIG. 6, the UE may obtain 3 as a K2 value corresponding to a slot offset value relating to PDCCH-to-PUSCH, and accordingly, the PUSCH 605 may be transmitted in slot 3 609 spaced 3 slots apart from slot 0 606 that is a time point at which a PDCCH 601 is received.

In an example 610 in FIG. 6, a UE may obtain a DCI format 0_1 by monitoring a PDCCH 611, and obtain scheduling information of a PUSCH 615 and CSI request information from the DCI format 0_1. The UE may obtain resource information of a CSI-RS 612 to be measured, from a received CSI request indicator. In the example 610 in FIG. 6, an offset value for the CSI-RS as described above is configured to be X=1. A UE may receive a CSI-RS 612 in a slot (corresponding to slot 0 616 in FIG. 6) having received a DCI format 0_1 triggering aperiodic CSI reporting, and may report CSI information measured by the received CSI-RS, through a PUSCH 615 to the base station.

An aperiodic CSI report may include at least one of CSI part 1 or CSI part 2 or both, and if an aperiodic CSI report is transmitted through a PUSCH, the aperiodic CSI report may be multiplexed with a transport block. For multiplexing, a CRC may be inserted in an input bit of aperiodic CSI, then the aperiodic CSI may be encoded and rate-matched and then be mapped to a resource element in a PUSCH according to a particular pattern and be transmitted. The CRC insertion may be omitted according to a coding method or the length of input bits. The number of modulation symbols calculated for rate matching when CSI part 1 or CSI part 2 included in an aperiodic CSI report is multiplexed may be obtained as shown in [Table 12] below.

```
TABLE 12
For CSI part 1 transmission on PUSCH not using repetition type B with
UL-SCH, the number of coded modulation symbols per layer for CSI
part 1 transmission, denoted as Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , {all}^{- 1}}^{PUSCH}} {M}_{SC}^{UCI} ( l )}{{\sum }_{r = 0}^{{{C}_{UL - {SCH}^{- 1}}}^{}} {K}_{r}} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} \}$
. . .
For CSI part 1 transmission on an actual repetition of a PUSCH with
repetition Type B with UL-SCH, the number of coded modulation symbols
per layer for CSI part 1 transmission, denoted as Q_{CSI-part1}′, is determined
as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , {nominal}^{- 1}}^{PUSCH}} {M}_{sc , nominal}^{UCI} ( l )}{{\sum }_{r = 0}^{{{C}_{UL - {SCH}^{- 1}}}^{}} {K}_{r}} ⌉ , \\ ⌈ α \cdot {\sum }_{l = 0}^{{N}_{symb , {nominal}^{- 1}}^{PUSCH}} {M}_{sc , nominal}^{UCI} ( l ) ⌉ - {Q}_{ACK / CG - UCI}^{′} , {\sum }_{l = 0}^{{N}_{symb , {actual}^{- 1}}^{PUSCH}} {M}_{sc , actual}^{UCI} ( l ) - {Q}_{ACK / CG - UCI}^{′} \}$
. . .
For CSI part 1 transmission on PUSCH without UL-SCH, the number of
coded modulation symbols per layer for CSI part 1 transmission,
denoted as Q_{CSI-part1}′, is determined as follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , {all}^{- 1}}^{PUSCH}} {M}_{sc}^{UCI} ( l ) - {Q}_{ACK}^{′} \}$
else
        Q_{CSI-1}′ = Σₗ₌₀^{N}_{symb,all}^{^{PUSCH}}⁻¹ M_{sc}^{UCI}(l) - Q_{ACK}′
end if
. . .
For CSI part 2 transmission on PUSCH not using repetition type B with
UL-SCH, the number of coded modulation symbols per layer for CSI
part 2 transmission, denoted as Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{{C}_{UL - {SCH}^{- 1}}}^{}} {K}_{r}} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with
repetition Type B with UL-SCH, the number of coded modulation symbols
per layer for CSI part 2 transmission, denoted as Q_{CSI-part2}′, is determined
as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {nominal}^{- 1}}^{PUSCH}} {M}_{sc , nominal}^{UCI} ( l )}{{\sum }_{r = 0}^{{{C}_{UL - {SCH}^{- 1}}}^{}} {K}_{r}} ⌉ , ⌈ α \cdot {\sum }_{l = 0}^{{N}_{symb , {nominal}^{- 1}}^{PUSCH}} {M}_{sc , nominal}^{UCI} ( l ) ⌉ - {Q}_{ACK / CG - UCI}^{′} - {Q}_{CSI - 1}^{′} , {\sum }_{l = 0}^{{N}_{symb , {actual}^{- 1}}^{PUSCH}} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of
coded modulation symbols per layer for CSI part 2 transmission, denoted
as Q_{CSI-part2}′, is determined as follows:
        Q_{CSI-2}′ = Σₗ₌₀^{N}_{symb,all}^{^{PUSCH}}⁻¹ M_{sc}^{UCI}(l) - Q_{ACK}′ - Q_{CSI-1}′
```

Particularly, in a case of PUSCH repetition schemes A and B, a UE may multiplex and transmit an aperiodic CSI report only at the first repetition among PUSCH repetitions. Since aperiodic CSI report information that is multiplexed is encoded in a polar code scheme, when the aperiodic CSI report information is multiplexed at several PUSCH repetitions, each PUSCH repetition is required to have the same frequency and time resource allocation. In particular, in a case of PUSCH repetition type B, each actual repetition may have a different OFDM symbol length, and thus an aperiodic CSI report may be multiplexed and transmitted only at the first PUSCH repetition.

In addition, with respect to PUSCH repetition scheme B, in a case where a UE schedules an aperiodic CSI report without scheduling a transport block or receives DCI activating a semi-persistent CSI report, even if a PUSCH repetition count configured through higher layer signaling is greater than 1, the value of a nominal repetition may be assumed to be 1. In addition, in a case where the UE schedules or activates an aperiodic or semi-persistent CSI report without scheduling a transport block, based on PUSCH repetition scheme B, the UE may expect that the first nominal repetition is the same as the first actual repetition. With respect to a PUSCH which includes semi-persistent CSI and is transmitted based on PUSCH repetition scheme B without scheduling of DCI after a semi-persistent CSI report is activated through DCI, if the first nominal repetition is different from the first actual repetition, transmission at the first nominal repetition may be disregarded.

### [CSI Computation Time]

When a base station indicates an aperiodic CSI report or a semi-persistent CSI report to a UE through DCI, the UE may discriminate whether the UE is able to perform valid channel reporting through the indicated CSI report, by considering a channel computation time (CSI computation time) required for the CSI report. With respect to an aperiodic CSI report or a semi-persistent CSI report indicated through DCI, a UE may perform valid CSI reporting starting from an uplink symbol after Z symbols after end of the last symbol included in a PDCCH including the DCI indicating the CSI report, and the Z symbols may vary according to the numerology of downlink bandwidth part corresponding to a PDCCH including DCI indicating a CSI report, the numerology of an uplink bandwidth part corresponding to a PUSCH transmitting the CSI report, and the type or the characteristic (report quantity, frequency band granularity, the number of ports of a reference signal, the type of a codebook, etc.) of channel information reported in the CSI report. In other words, in order for a CSI report to be determined as a valid CSI report (the CSI report to be a valid CSI report), uplink transmission of the CSI report needs to be not performed before Zref symbols including a timing advance. Zref symbols are uplink symbols on which a cyclic prefix (CP) is started after the time T_{proc,CSI}=(Z)(2048+144)·κ2^{-μ}·T_{C} from the moment at which the last symbol of the triggering PDCCH is ended. According to an embodiment, a detailed value of Z follows the description below, T_{c}=1/(Δfₘₐₓ·N_{f}), Δfₘₐₓ=480·10³ Hz, N_{f}=4096, and κ=64, and μ indicates numerology. For example, u may be promised to be one among (μ_{PDCCH},μ_{CSI-RS}, μ_{UL}), which causes the greatest T_{proc,CSI} value, and μ_{PDCCH} may be referred to as a subcarrier spacing used for PDCCH transmission, μ_{CSI-RS} may be referred to as a subcarrier spacing used for CSI-RS transmission, and μ_{UL} may be referred to as a subcarrier spacing of an uplink channel used in uplink control information (UCI) transmission for CSI reporting. As another example, it is possible to promise to use, as u, one among (μ_{PDCCH}, μ_{UL}), which causes the greatest T_{proc,CSI} value. The definitions of μ_{PDCCH} and μ_{UL} refers to the above description. For convenience of explanation in the future, satisfying the above condition is called satisfying CSI reporting validity condition 1.

In addition, if a reference signal for channel measurement for an aperiodic CSI report indicated to a UE through DCI is an aperiodic reference signal, a UE may perform valid CSI reporting starting from an uplink symbol after Z′ symbols after end of the last symbol including the reference signal. The Z′ symbols described above may vary according to the numerology of downlink bandwidth part corresponding to a PDCCH including DCI indicating a CSI report, the numerology of a bandwidth corresponding to a reference signal for channel measurement for the CSI report, the numerology of an uplink bandwidth part corresponding to a PUSCH transmitting the CSI report, and the type or the characteristic (report quantity, frequency band granularity, the number of ports of a reference signal, the type of a codebook, etc.) of channel information reported in the CSI report. In other words, in order for a CSI report to be determined as a valid CSI report (the CSI report to be a valid CSI report), uplink transmission of the CSI report needs to be not performed before Zref symbols including a timing advance. The Zref symbols are uplink symbols on which a cyclic prefix (CP) is started after the time T′_{proc,CSI}=(Z′)(2048+144)·κ2^{-μ}·T_{C} from the moment at which the last symbol of an aperiodic CSI-RS or an aperiodic CSI-IM triggered by the triggering PDCCH is ended. According to an embodiment, a detailed value of Z′ follows the description below, T_{c}=1/(Δfₘₐₓ·N_{f}), Δfₘₐₓ=480·10³ Hz, N_{f}=4096, and κ=64, and μ indicates numerology. For example, u may be promised to be one among (μ_{PDCCH}, μ_{CSI-RS}, μ_{UL}), which causes the greatest T_{proc,CSI} value, and μ_{PDCCH} may be referred to as a subcarrier spacing used for triggering PDCCH transmission, μ_{CSI-RS} may be referred to as a subcarrier spacing used for CSI-RS transmission, and Luz may be referred to as a subcarrier spacing of an uplink channel used in uplink control information (UCI) transmission for CSI reporting. As another example, u may be promised to be one among (μ_{PDCCH}, μ_{UL}), which causes the greatest T_{proc,CSI} value. The definitions of μ_{PDCCH} and μ_{UL} refers to the above description. For convenience of explanation in the future, satisfying the above condition is called satisfying CSI reporting validity condition 2.

In a case where a base station indicates an aperiodic CSI report for an aperiodic reference signal to a UE through DCI, the UE may perform valid CSI reporting starting from a first uplink symbol satisfying both a time point after Z symbols after end of the last symbol included in a PDCCH including the DCI indicating the CSI report and a time point after Z′ symbols after end of the last symbol including the reference signal. For example, in a case of aperiodic CSI reporting based on an aperiodic reference signal, the CSI report is required to satisfy both CSI reporting validity conditions 1 and 2 so that the UE determines the CSI report as a valid CSI report.

If a CSI report time point indicated by a base station fails to satisfy a CSI computation time requirement, a UE may determine that the CSI report is not valid and may not consider update of a channel information state for the CSI report.

Z and Z′ symbols for CSI computation time calculation described above follow [Table 13] and [Table 14] below. For example, if channel information reported by a CSI report includes only wideband information, the number of ports of a reference signal is equal to or smaller than 4, the number of reference signal resources is 1, and the type of a codebook is “typeI-SinglePanel” or the type (report quantity) of the reported channel information is “cri-RI-CQI,” Z and Z′ symbols follow Z₁, Z′₁ values in [Table 14]. Hereinafter, this is called delay requirement 2. Furthermore, if a PUSCH including a CSI report does not include a TB or an HARQ-ACK and the CPU occupation of a UE is 0, Z and Z′ symbols follow Z₁, Z′₁ values in [Table 13] and this is called delay requirement 1. A description of the CPU occupation is given below in detail. In addition, if report quantity is “cri-RSRP” or “ssb-Index-RSRP,” Z and Z′ symbols follow Z₃, Z′₃ values in [Table 14]. X1, X2, X3, and X4 in [Table 14] indicates UE (UE) capability for a beam reporting time, and KB1 and KB2 in [Table 14] mean UE capability for a beam change time. If channel information does not correspond to the type or characteristic of the channel information reported in a CSI report described above, Z and Z′ symbols follow Z₂, Z′₂ values in [Table 14].

TABLE 13

| | Z₁ [symbols] | |
|---|---|---|
| μ | Z₁ | Z₁′ |
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### [Description for CSI Reference Resource]

When a base station indicates an aperiodic/semi-persistent/periodic CSI report to a UE, the base station may configure a CSI reference resource to determine a reference time and frequency for a channel to be reported in a CSI report. The frequency of a CSI reference resource may be information on a carrier or subband in which CSI is to be measured, which is indicated in a CSI report configuration, and these information may correspond to carrier and reportFreqConfiguration in the higher layer signaling CSI-ReportConfig, respectively. The time of a CSI reference resource may be defined based on a time at which a CSI report is transmitted. For example, if CSI report #X is indicated to be transmitted on uplink slot n′ of a carrier and a BWP in which a CSI report is to be transmitted, the time of a CSI reference resource of CSI report #X may be defined to be downlink slot n-nCSI-ref of a carrier and a BWP in which CSI is measured. Downlink slot n is calculated by n=└n′·2^{μ}^{_{DL}}/2^{μ}^{_{UL}}┘ when the numerology of a carrier and a BWP in which CSI is measured is called μDL and the numerology of a carrier and a BWP in which CSI report #X is transmitted is called μUL. nCSI-ref, which is a slot interval between downlink slot n and a CSI reference signal, is based on the number of CSI-RS/SSB resources for channel measurement when CSI report #X transmitted on uplink slot n′ is a semi-persistent or periodic CSI report, follows n_{CSI-ref}=4·2^{μ}^{_{DL}} if a single CSI-RS/SSB resource is connected to the CSI report, and follows n_{CSI-ref}=5·2^{μ}^{_{DL}} if multiple CSI-RS/SSB resources are connected to the CSI report. If CSI report #X transmitted on uplink slot n′ is an aperiodic CSI report, nCSI-ref may be calculated by n_{CSI-ref}=└Z′/N_{symb}^{slot}┘ in consideration of CSI computation time Z′ for channel measurement. N_{symb}^{slot} described above is the number of symbols included in one slot, and N_{symb}^{slot}=14 is assumed in NR.

In a case where a base station indicates, through higher layer signaling or DCI, a UE to transmit a CSI report on uplink slot n′, the UE may report CSI by performing channel measurement or interference measurement for a CSI-RS resource, a CSI-IM resource, or an SSB resource, among CSI-RS resources, CSI-IM resources, or SSB resources associated with the CSI report, which has been transmitted no later than a CSI reference resource slot of the CSI report transmitted on uplink slot n′. A CSI-RS resource, a CSI-IM resource, or an SSB resource associated with the CSI report may be a CSI-RS resource, a CSI-IM resource, or an SSB resource included in a resource set configured in a resource setting referred to by a report setting for the CSI report of a UE configured through higher layer signaling, or may indicate a CSI-RS resource, a CSI-IM resource, or an SSB resource referred to by a CSI report trigger state including a parameter for the CSI report, or a CSI-RS resource, a CSI-IM resource, or an SSB resource indicated by an ID of a reference signal (RS) set.

In embodiments of the disclosure, a CSI-RS/CSI-IM/SSB occasion may denote a transmission time point of a CSI-RS/CSI-IM/SSB resource(s) determined by a higher layer configuration or a combination of a higher layer configuration and DCI triggering. For example, a slot on which a semi-persistent or periodic CSI-RS resource is transmitted is determined according to a slot period and a slot offset configured through higher layer signaling, and a transmission symbol(s) in the slot is determined according to resource mapping information (resourceMapping). As another example, a slot on which an aperiodic CSI-RS resource is transmitted is determined according to a slot offset from a PDCCH including DCI indicating channel reporting configured through higher layer signaling, and a transmission symbol(s) in the slot is determined according to resource mapping information (resourceMapping).

A CSI-RS occasion described above may be determined by independently considering a transmission time point of each CSI-RS resource or collectively considering transmission time points of one or more CSI-RS resource(s) included in a resource set, and therefore, the following two interpretations for a CSI-RS occasion according to each resource set configuration are possible.
Interpretation 1-1: From the start time point of the earliest symbol to the end time point of the latest symbol on which one particular resource is transmitted among one or more CSI-RS resources included in a resource set(s) configured in a resource setting referred to by a report setting configured for a CSI report.
Interpretation 1-2: From the start time point of the earliest symbol on which the earliest transmitted CSI-RS resource is transmitted among all CSI-RS resources included in a resource set(s) configured in a resource setting referred to by a report setting configured for a CSI report, to the end time point of the latest symbol on which the latest transmitted CSI-RS resource is transmitted.

Hereinafter, embodiments of the disclosure are applicable individually in consideration of both of the two interpretations for a CSI-RS occasion. In addition, the two interpretations as considered for a CSI-RS occasion are also considerable for a CSI-IM occasion and an SSB occasion. However, the principle thereof is similar to the above description, and thus an overlapped description will be omitted.

In embodiments of the disclosure, “a CSI-RS/CSI-IM/SSB occasion for CSI report #X transmitted on uplink slot n′” indicates a set of CSI-RS occasions, CSI-IM occasions, or SSB occasions not later than a CSI reference resource of CSI report #X transmitted on uplink slot n′ among CSI-RS occasions, CSI-IM occasions, and SSB occasions of CSI-RS resources, CSI-IM resources, and SSB resources included in a resource set configured in a resource setting referred to by a report setting configured for CSI report #X.

In embodiments of the disclosure, the following two interpretations for “the latest CSI-RS/CSI-IM/SSB occasion among CSI-RS/CSI-IM/SSB occasions for CSI report #X transmitted on uplink slot n′” are possible.
Interpretation 2-1: A set of occasions including the latest CSI-RS occasion among CSI-RS occasions for CSI report #X transmitted on uplink slot n′, the latest CSI-IM occasion among CSI-RS occasions for CSI report #X transmitted on uplink slot n′, and the latest SSB occasion among SSB occasions for CSI report #0 transmitted on uplink slot n.′
Interpretation 2-2: The latest occasion among all CSI-RS occasions, CSI-IM occasions, and SSB occasions for CSI report #0 transmitted on uplink slot n.′

In embodiments of the disclosure, the two interpretations for “the latest CSI-RS/CSI-IM/SSB occasion among CSI-RS/CSI-IM/SSB occasions for CSI report #X transmitted on uplink slot n′ are individually applicable by being considered in combination. In addition, in consideration of the above two interpretations (interpretation 1-1 and interpretation 1-2) for CSI-RS occasions, CSI-IM occasions, and SSB occasions, four different interpretations (application of interpretation 1-1 and interpretation 2-1, application of interpretation 1-1 and interpretation 2-2, application of interpretation 1-2 and interpretation 2-1, and application of interpretation 1-2 and interpretation 2-2) are individually applicable by being considered in combination with respect to “the latest CSI-RS/CSI-IM/SSB occasion among CSI-RS/CSI-IM/SSB occasions for CSI report #X transmitted on uplink slot n′” in embodiments of the disclosure.

The base station may indicate a CSI report, based on the amount of channel information simultaneously calculatable for the CSI report (for example, the number of channel information calculation units (CSI processing units, CPUs) of the UE). If the number of channel information calculation units which the UE is able to simultaneously calculate is N_{CPU}, the UE may not expect a CSI report indication from the base station, which requires calculation of channel information larger than, N_{CPU} or may not consider update of channel information requiring calculation of channel information larger than N_{CPU}. N_{CPU} may be reported by the UE to the base station through higher layer signaling or may be configured by the base station through higher layer signaling.

It is assumed that a CSI report indicated by a base station to a UE occupies some or all of CPUs for channel information calculation among N_{CPU}, the total number related to channel information which the UE is able to simultaneously calculate. If the number of channel information calculation units required in each CSI report, for example, CSI report n (n=0, 1, . . . , N−1), is O_{CPU}⁽ⁿ⁾, the number of channel information calculation units required for a total of N CSI reports may be referred to as

$${\sum }_{n = 0}^{N - 1} {O}_{CPU}^{( n )} .$$

Channel Information calculation units required for each reportQuantity configured for a CSI report may be configured as in [Table 15] below.

TABLE 15

- O_{CPU}⁽ⁿ⁾ = 0 : A case where reportQuantity configured in a CSI report is configured to be “none,”
and trs-Info is configured in a CSI-RS resource set connected to the CSI report
- O_{CPU}⁽ⁿ⁾ = 1 : A case where reportQuantity configured in a CSI report is configured to be “none,”
“cri-RSRP“ or “ssb-Index-RSRP,” and trs-Info is not configured in a CSI-RS resource set
connected to the CSI report
- A case where reportQuantity configured in a CSI report is configured to be “cri-RI-PMI-CQI,”
“cri-RI-il,” “cri-RI-i1-CQI,” “cri-RI-CQI,” or “cri-RI-LI-PMI-CQI”
>> O_{CPU}⁽ⁿ⁾ = N_{CPU} : A case where an aperiodic CSI report is triggered and is not multiplexed
with one of a TB/HARQ-ACK or both. A case where the CSI report includes wideband CSI,
corresponds to a maximum of 4 CSI-RS ports, and corresponds to a single resource without a
CRI report, codebookType corresponds to “typeI-SinglePanel” or reportQuantity corresponds to
“cri-RI-CQI” (The case correspond to the above delay requirement 1, and herein, the UE quickly
calculates CSI by using all available CPUs and then reports same).
>> O_{CPU}⁽ⁿ⁾ = Kₛ : All the remaining cases other than the above case. Kₛ indicates the number of
CSI-RS resources in a CSI-RS resource set for channel measurement.

When the number of channel information calculation required by a UE for multiple CSI reports at a particular time point is greater than the number N_{CPU} of channel information calculation units that the UE is able to simultaneously calculate, the UE may not consider update of channel information for some CSI reports. A CSI report, among multiple indicated CSI reports, for which update of channel information is not considered is determined by considering at least the priority of reported channel information and a time for which channel information calculation required for the CSI report occupies CPUs. For example, update of channel information for a CSI report for which a time for which channel information calculation required for the CSI report occupies CPUs starts at the latest time point may not be considered, and it is possible not to preferentially consider update of channel information for a CSI report having a low priority of channel information.

The priority of the channel information may be determined by referring to [Table 16] below.

TABLE 16

CSI priority value Pri_{iCSI}(y, k, c, s) = 2 · N_{cells} · Mₛ · y + N_{cells} · Mₛ · k + Mₛ · c + s
- y = 0, in a case of an aperiodic CSI report transmitted through a PUSCH, y = 1, in a
case of a semi-persistent CSI report transmitted through a PUSCH, y = 2, in a case of a semi-
persistent CSI report transmitted through a PUCCH, and y = 3, in a case of a periodic CSI
report transmitted through a PUCCH;
- k = 0 when a CSI report includes L1-RSRP, and k = 1 when a CSI report does not
include L1-RSRP;
- c: Serving cell index, and N_{cells} : A maximum number (maxNrofServingCells) of
serving cells configured through higher layer signaling;
- s: CSI report configuration index (reportConfigID), and Mₛ : A maximum number
(maxNrofCSI-ReportConfigurations)of CSI report configurations configured through higher
layer signaling.

A CSI priority for a CSI report is determined through the priority value PriiCSI(y, k, c, s) in [Table 16]. Referring to [Table 16], a CSI priority value is determined through the type of channel information included in a CSI report, the time axis reporting characteristic (aperiodic, semi-persistent, or periodic) of the CSI report, a channel (PUSCH or PUCCH) through which the CSI report is transmitted, a serving cell index, or a CSI report configuration index. In relation to a CSI priority for a CSI report, the priority values of PriiCSI (y, k, c, s) are compared, whereby the CSI priority of a CSI report having a small priority value is determined to be high.

When a time for which channel information calculation required for a CSI report indicated by a base station to a UE occupies CPUs is a CPU occupation time, the CPU occupation time is determined considering the type (report quantity) of channel information included in the CSI report, the time axis characteristic (aperiodic, semi-persistent, or periodic) of the CSI report, a slot or symbol occupied by higher layer signaling or DCI indicating the CSI report, or some or all of symbols or slots occupied by a reference signal for channel state measurement.

### [PDCCH: Regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. For example, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 17 below, for example.

TABLE 17

| | |
|---|---|
| - | Identifier for DCI formats - [1] bit |
| - | Frequency domain resource assignment -[ ┌log₂ (N_{RB}^{UL,BWP} (N_{RB}^{UL,BWP} + 1) / 2) ┐ ] |

bits

| | |
|---|---|
| - | Time domain resource assignment - X bits |
| - | Frequency hopping flag - 1 bit. |
| | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH - [2] bits |
| - | Uplink/ supplementary uplink (UL/SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 18 below, for example.

```
TABLE 18
Carrier indicator - 0 or 3 bits
UL/SUL indicator - 0 or 1 bit
Identifier for DCI formats - [1] bits
Bandwidth part indicator - 0, 1 or 2 bits
Frequency domain resource assignment
    * For resource allocation type 0, └N_{RB}^{UL,BWP} / P┐ bits
    * For resource allocation type 1,
    ┌log₂ (N_{RB}^{UL,BWP} (N_{RB}^{UL,BWP} +1) /2)┐ bits
Time domain resource assignment -1, 2, 3, or 4 bits
Virtual resource block (VRB)-to-physical resource block (PRB)
mapping - 0 or 1 bit, only for resource allocation type 1.
    * 0 bit if only resource allocation type 0 is configured;
    * 1 bit otherwise.
Frequency hopping flag - 0 or 1 bit, only for resource allocation type 1.
    * 0 bit if only resource allocation type 0 is configured;
    * 1 bit otherwise.
Modulation and coding scheme - 5 bits
New data indicator - 1 bit
Redundancy version - 2 bits
HARQ process number - 4 bits
1st downlink assignment index - 1 or 2 bits
    * 1 bit for semi-static HARQ-ACK codebook;
    * 2 bits for dynamic HARQ-ACK codebook with single HARQ-ACK
    codebook.
2nd downlink assignment index - 0 or 2 bits
    * 2 bits for dynamic HARQ-ACK codebook with two HARQ-ACK
    sub-codebooks;
    * 0 bit otherwise.
TPC command for scheduled PUSCH - 2 bits
SRS resource indicator - $⌈ {log}_{2} ( {\sum }_{k = l}^{{L}_{\text{?}}} ( \begin{matrix}{N}_{SRS} \\ k\end{matrix} ) ) ⌉$
or ┌log₂ (N_{SRS})┐ bits
    * $⌈ {log}_{2} ( {\sum }_{k = l}^{{L}_{\text{?}}} ( \begin{matrix}{N}_{SRS} \\ k\end{matrix} ) ) ⌉$
    bits for non-codebook based PUSCH transmission;
    * ┌log₂ (N_{SRS})┐ bits for codebook based PUSCH transmission.
Precoding information and number of layers - up to 6 bits
Antenna ports - up to 5 bits
SRS request - 2 bits
Channel state information (CSI) request - 0, 1, 2, 3, 4, 5, or 6 bits
Code block group (CBG) transmission information - 0, 2, 4, 6, or 8 bits
Phase tracking reference signal (PTRS)-demodulation reference signal
(DDMRS) association - 0 or 2 bits.
beta_offset indicator - 0 or 2 bits
DMRS sequence initialization - 0 or 1 bit

[symbol]

[symbol]

indicates data missing or illegible when filed
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 19 below, for example.

TABLE 19

| | |
|---|---|
| - | Identifier for DCI formats - [1] bit |
| - | Frequency domain resource assignment -[ ┌log₂ (N_{RB}^{DL,BWP} (N_{RB}^{DL,BWP} + 1) / 2) ┐ ] |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Pysical uplink control channel (PUCCH) resource indicator - 3 bits |
| - | PDSCH-to-HARQ feedback timing indicator - [3] bits |

DCI format 1_1 may be used as non-fallback DCI for scheduling a PDSCH, and in this case, the CRC may be scrambled by a C-RNTI DCI format 1_1 in which the CRC is scrambled by a C-RNTI may include the following pieces of information given in Table 20 below, for example.

TABLE 20

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | * For resource allocation type 0, ┌N_{RB}^{DL,BWP} / P ┐ bits |
| | * For resource allocation type 1, ┌log₂ (N_{RB}^{DL,BWP} (N_{RB}^{DL,BWP} + 1) / 2) ┐ bits |
| - | Time domain resource assignment −1, 2, 3, or 4 bits |
| - | VRB-to-PRB mapping - 0 or 1 bit, only for resource allocation type 1. |
| | * 0 bit if only resource allocation type 0 is configured; |
| | * 1 bit otherwise. |
| - | Physical resource block (PRB) bundling size indicator - 0 or 1 bit |
| - | Rate matching indicator - 0, 1, or 2 bits |
| - | Zero power (ZP) channel state information (CSI)-reference signal (RS) trigger |

- 0, 1, or 2 bits
For transport block 1:

- Modulation and coding scheme - 5 bits
- New data indicator - 1 bit
- Redundancy version - 2 bits

For transport block 2:

| | |
|---|---|
| | - Modulation and coding scheme - 5 bits |
| | - New data indicator - 1 bit |
| | - Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

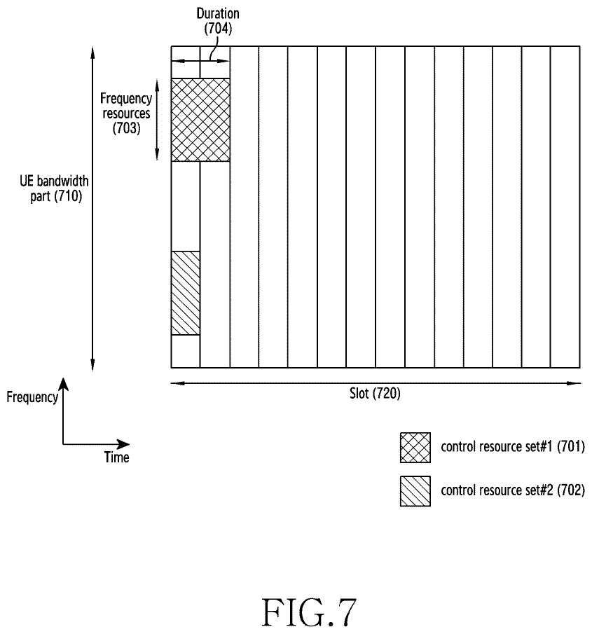

FIG. 7 illustrates an example of a control resource set (CORESET) used to transmit a downlink control channel in a 5G wireless communication system. FIG. 7 illustrates an example in which a UE bandwidth part 710 is configured along the frequency axis, and two CORESETs (CORESET #1 701 and CORESET #2 702 are configured within one slot 720 along the time axis. The CORESETs 701 and 702 may be configured in a specific frequency resource 703 within the entire UE bandwidth part 710 along the frequency axis. One or multiple OFDM symbols may be configured along the time axis, and this may be defined as a control resource set duration 704. Referring to the example illustrated in FIG. 7, CORESET #1 701 is configured to have a control resource set duration corresponding to two symbols, and CORESET #2 702 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, this information may include the following pieces of information given in Table 21 below.

TABLE 21

```
  ConControlResourceSet ::= SEQUENCE {
-- Corresponds to L1 parameter ‘CORESET-ID’
  controlResourceSetId ControlResourceSetId,
    (control resource set identity)
  frequencyDomainResources BIT STRING (SIZE (45)),
    (frequency domain resource assignment information)
  duration INTEGER (1..maxCoReSetDuration),
    (time domain resource assignment information)
  cce-REG-MappingType CHOICE {
    (CCE-to-REG mapping type)
    interleaved SEQUENCE {
        reg-BundleSize ENUMERATED {n2, n3, n6},
    (REG bundle size)
        precoderGranularity ENUMERATED { sameAsREG-bundle,
allContiguousRBs},
        interleaverSize ENUMERATED {n2, n3, n6}
        (interleaver size)
        shiftIndex INTEGER(0..maxNrofPhysicalResourceBlocks-1)
                        OPTIONAL
      (interleaver shift)
      },
    nonInterleaved NULL
      },
    tci-StatesPDCCH SEQUENCE(SIZE (1..maxNrofTCI-
StatesPDCCH)) OF TCI-StateId OPTIONAL,
      (QCL configuration information)
    tci-PresentInDCI ENUMERATED {enabled}
    OPTIONAL, -- Need S
    }
```

In Table 21, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET.

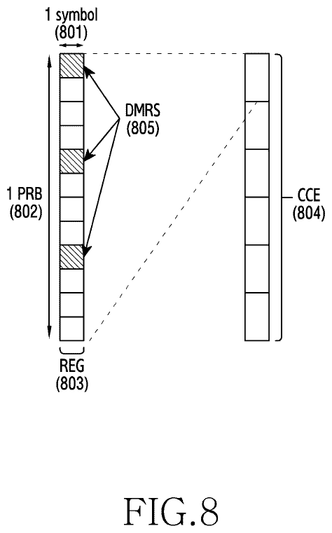

FIG. 8 illustrates an example of a basic unit of time and frequency resources constituting a downlink control channel available in a 5G system. According to FIG. 8, the basic unit of time and frequency resources constituting a control channel may be referred to as a resource element group (REG) 803, and the REG 803 may be defined by one OFDM symbol 801 along the time axis and one physical resource block (PRB) 802 (for example, 12 subcarriers), along the frequency axis. The base station may constitute a downlink control channel allocation unit by connecting REGs 803.

Provided that the basic unit of downlink control channel allocation in 5G is a control channel element 804 as illustrated in FIG. 8, one CCE 804 may include multiple REGs 803. To describe the REG 803 illustrated in FIG. 8, for example, the REG 803 may include 12 REs, and if one CCE 804 includes six REGs 803, one CCE 804 may then include 72 REs. A downlink control resource set, once configured, may include multiple CCEs 804 and a specific downlink control channel may be mapped to one or multiple CCEs 804 and then transmitted according to the aggregation level (AL) in the control resource set. The CCEs 804 in the control resource set may be distinguished by numbers, and the numbers of CCEs 804 may be allocated according to a logical mapping scheme.

The basic unit of the downlink control channel illustrated in FIG. 8 (for example, the REG 803), may include both REs to which DCI is mapped, and an area to which a reference signal (DMRS 805) for decoding the same is mapped. As in FIG. 8, three DMRSs 805 may be transmitted inside one REG 803. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, this information may include the following pieces of information: given in Table 22 below.

TABLE 22

```
  SearchSpace ::= SEQUENCE {
    -- Identity of the search space. SearchSpaceId = 0 identifies the SearchSpace configured via
PBCH (MIB) or ServingCellConfigCommon.
    searchSpaceId SearchSpaceId,
    (search space identity)
    controlResourceSetId ControlResourceSetId,
    (control resource set identity)
    monitoringSlotPeriodicityAndOffset CHOICE {
    (monitoring slot level periodicity)
        sl1 NULL,
        sl2 INTEGER (0..1),
        sl4 INTEGER (0..3),
        sl5 INTEGER (0..4),
        sl8 INTEGER (0..7),
        sl10 INTEGER (0..9),
        sl16 INTEGER (0..15),
        sl20 INTEGER (0..19)
    }
                            OPTIONAL,
    duration (monitoring duration) INTEGER (2..2559)
    monitoringSymbolsWithinSlot BIT STRING (SIZE (14))
                                    OPTIONAL,
    (monitoring symbols within slot)
    nrofCandidates SEQUENCE {
    (number of PDCCH candidates for each aggregation level)
        aggregationLevel1 ENUMERATED {n0, n1, n2, n3, n4, n5, n6,
n8},
        aggregationLevel2 ENUMERATED {n0, n1, n2, n3, n4, n5, n6,
n8},
        aggregationLevel4 ENUMERATED {n0, n1, n2, n3, n4, n5, n6,
n8},
        aggregationLevel8 ENUMERATED {n0, n1, n2, n3, n4, n5, n6,
n8 },
        aggregationLevel16 ENUMERATED {n0, n1, n2, n3, n4, n5, n6,
n8}
    },
    searchSpace Type CHOICE {
    (search space type)
    -- Configures this search space as common search space (CSS) and DCI formats to monitor.
        common SEQUENCE {
    (common search space)
      }
    ue-Specific SEQUENCE {
    (UE-specific search space)
        -- Indicates whether the UE monitors in this USS for DCI formats 0-0 and 1-0 or for
formats 0-1 and 1-1.
        formats ENUMERATED {formats0-0-And-1-0,
formats0-1-And-1-1},
            ...
                  }
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Obviously, the example given below is not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

Enumerated RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI) for indicating power control command for PUCCH; and/or
Transmit power control for SRS RNTI (TPC-SRS-RNTI): used to indicate a power control command regarding an SRS.

The DCI formats enumerated above may follow the definitions given in Table 23 below.

TABLE 23

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In 5G, the search space at aggregation level L in connection with CORESET p and search space set s may be expressed by Equation 1 below:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L−i=0, . . . , L−1
Y_{p,n}_{_{s,f}}_{^{μ}}−(Aₚ·Y_{p,n}_{_{s,f}}_{^{μ}}₋₁) mod D, Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 22), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [Regarding UE Capability Report]

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. For example, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.

1. If the UE receives a list regarding LTE and/or NR bands from the base station at a UE capability request, the UE constructs band combinations (BCs) regarding EN-DC and NR standalone (SA). For example, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well and LTE bands are also applied. BCs remaining after the above step constitute the final “candidate BC list.”

4. The UE selects BCs appropriate for the requested RAT type from the final “candidate BC list” and thereby selects BCs to report. In this step, the UE configures supportedBandCombinationList in a determined order. The UE configures BCs and UE capability to report according to a preconfigured rat-Type order. (nr→eutra-nr→eutra).→(nr→eutra-nr→eutra) In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

### SPECIFIC EMBODIMENTS

Hereinafter, the operation principle of the disclosure will be described in detail in conjunction with the accompanying drawings. The contents of the disclosure may be applied to FDD and TDD systems. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling,” “PDCP signaling,” or “MAC control element (MAC CE).”

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

In the disclosure, a beam may be understood as an SSB beam or resource.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it may be assumed for the sake of descriptive convenience that NC-JT case refers to a case in which the UE receives a PDSCH to which cooperative communication is applied, based on conditions similar to those described above.

Hereinafter, embodiments of the disclosure will be described in detail in conjunction with the accompanying drawings. In the following description, a base station is an entity that allocates resources to terminals, and may be at least one of a gNode B, a gNB, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description, embodiments of the disclosure will be described in connection with 5G systems by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); or
Uplink control information (UCI).

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through several embodiments, but they are not independent of each other, and one or more embodiments may be applied simultaneously or in combination.

### First Embodiment: Method of Supporting CSI-RS Configured by More than 32 CSI-RS Ports

As an embodiment of the disclosure, a method of supporting a CSI-RS having 64 or more ports by a UE is described. This embodiment may be operated in combination with other embodiments.

Referring to [Table 7], the UE may define a maximum of 32 CSI-RS ports in one CSI-RS resource. If a base station is able to use more than 32 antenna ports (e.g., 64, 96, or 128 antenna ports), when more than 32 CSI-RS ports required to estimate a downlink channel between the base station and the UE are defined, the UE and the base station may generally consider [Method 1-1] and [Method 1-2].

### [Method 1-1] Single CSI-RS Resource-Based Support Method

The UE and the base station may define more than 32 CSI-RS ports, based on a single CSI-RS resource. For example, the base station and the UE may include 64, 96, 128, or 256 CSI-RS ports, the number of which is greater than 32, in a single CSI-RS resource, and define the higher layer signaling CSI-RS-ResourceMapping including a time and frequency resource RE mapping method, a CDM type, and a resource amount density on the frequency resources.
If more than 32 CSI-RS ports are included in a single CSI-RS resource, fd-CDM2, cdm4-FD2-TD2, or cdm8-FD2-TD4 defined for a 32-port CSI-RS may be used as a CDM type, or additionally, cdm16-FD4-TD4, cdm32-FD8-TD4, or cdm32-FD4-TD8 may be used:
If more than 32 CSI-RS ports are included in a single CSI-RS resource, 1 or 0.5 may be used as a resource amount density on the frequency resources, or additionally, 0.25 or 0.125 may be used. The value of the resource amount density on the frequency resources being 1, 0.5, 0.25, or 0.125 may imply that CSI-RS RE mapping is performed on every RB, every two RBs, every four RBs, or every eight RBs; and/or
If more than 32 CSI-RS ports are included in a single CSI-RS resource, the number of REs in one RB is 168 in a case of, for example, 256 CSI-RS ports, entire RE mapping may be impossible.

### [Method 1-2] Multi-CSI-RS Resource-Based Support Method

The UE and the base station may support more than 32 CSI-RS ports, based on multiple CSI-RS resources. If the number of CSI-RS ports to be represented through multiple CSI-RS resources is Pₜₒₜ, the number of CSI-RS ports represented through the i-th CSI-RS resource, and the number of the CSI-RS resources is N, P₁+ . . . +P_{N}=Pₜₒₜ may be valid. All the i-th CSI-RS resources may have the same number of CSI-RS ports or different numbers of CSI-RS ports. In addition, the minimum value of Pᵢ may be 1, 2, 4, 8, 12, 16, 24, or 32. For example, the UE may represent and support 64 CSI-RS ports by using two CSI-RS resources each including 32 ports. The two CSI-RS resources may be included in the same CSI-RS resource set, a CSI-RS resource having a lower index among the two CSI-RS resources may use ports 3000 to 3031 among the 64 ports, and a CSI-RS resource having a higher index may use ports 3032 to 3063 among the 64 ports. As another example, the UE may represent and support 128 CSI-RS ports by using four CSI-RS resources each including 32 ports. The four CSI-RS resources may be included in the same CSI-RS resource set, a CSI-RS resource having a n-th lowest index among the four CSI-RS resources may use ports 3000+(n−1)*32+1 to 3000+n*32−1.

If the UE supports Pₜₒₜ number of CSI-RS reports, which is greater than 32, by using multiple CSI-RS resources, the multiple CSI-RS resources may be configured for the UE by the base station through higher layer signalings, and the same value or different values of some or all of the higher layer signalings included in the multiple CSI-RS resources may be configured for the UE by the base station. The higher layer signaling for each CSI-RS resource may be configured in an NZP-CSI-RS-Resource parameter for the UE by the base station. Each higher layer signaling configurable in the higher layer signaling NZP-CSI-RS-Resource identifiable in [Table 6] above by the UE may have the same or different conditions according to multiple CSI-RS resources:
nzp-CSI-RS-ResourceId: the UE may expect that different IDs are configured for multiple CSI-RS resources;
powerControlOffset: the UE may expect that multiple CSI-RS resources have the same powerControlOffset value, and this may imply that the RE power ratios between the multiple CSI-RS resources and a PDSCH are the same;
powerControlOffsetSS: the UE may expect that multiple CSI-RS resources have the same powerControlOffsetSS value, and this may imply that the RE power ratios between the multiple CSI-RS resources and an SSB are the same;
scramblingID: the UE may expect that multiple CSI-RS resources have the same scramblingID value, and this may imply that the multiple CSI-RS resources are configured to all have the same scrambling ID;
periodicity AndOffset: the UE may expect that multiple CSI-RS resources have the same periodicity AndOffset value, and this may imply that the CSI-RS resources have all the same period and the same slot offset in a case of a periodic CSI-RS or a semi-persistent CSI-RS, and Pₜₒₜ number of CSI-RS ports supported through the multiple CSI-RS resources are all transmitted in the same slot. In another method, the UE may expect that multiple CSI-RS resources have the same period value and the same or different slot offset values among the periodicity AndOffset values, and this may imply that the CSI-RS resources have all the same period and the same slot offset in a case of a periodic CSI-RS or a semi-persistent CSI-RS, but the position of a slot on which CSI-RS ports included in each CSI-RS resource are transmitted may be different. In another method, the UE may expect that there is no restriction on the periodicity AndOffset values for multiple CSI-RS resources, and this may imply that there is no restriction on whether the period values and the slot offset values are the same or different from each other in a case of a periodic CSI-RS or a semi-persistent CSI-RS, may imply that, when the UE measures CSI-RS ports included in each CSI-RS resource, the UE may update information on corresponding some CSI-RS ports among Pₜₒₜ number of CSI-RS ports, and may imply that there is no need to always update information on all the CSI-RS ports at the same time or within a slight time; and/or
qcl-InfoPeriodicCSI-RS: the UE may expect that multiple CSI-RS resources have the same or different qcl-InfoPeriodicCSI-RS values. The UE may define the parameter only for a periodic CSI-RS, the parameter may have a value corresponding to TCI-StateId, and the TCI state ID may mean a parameter TCI-state or a particular dl-Or-Joint-TCI-State. If the UE have the same qcl-InfoPeriodicCSI-RS value for all multiple CSI-RS resources, this may imply that the UE receives Pₜₒₜ number of CSI-RS ports transmitted from similar positions. For example, Pₜₒₜ number of CSI-RS ports are all transmitted from TRPs, radio units (RUs), or massive MIMO units (MMUs) existing on the same or similar positions. On the contrary, if the UE have different qcl-InfoPeriodicCSI-RS values for multiple CSI-RS resources, CSI-RS ports included in the respective CSI-RS resources are transmitted from TRPs, RUs, or MMUs existing on different positions.

Additionally, the UE and the base station may define the higher layer signaling CSI-RS-ResourceMapping in [Table 6] above to include detailed parameters as shown in [Table 24] below, and the UE may receive configuration information on each parameter, based on higher layer signaling from the base station.

TABLE 24

```
CSI-RS-ResourceMapping ::= SEQUENCE {
    frequencyDomainAllocation CHOICE {
        row1 BIT STRING (SIZE (4)),
        row2 BIT STRING (SIZE (12)),
        row4 BIT STRING (SIZE (3)),
        other BIT STRING (SIZE (6))
    },
    nrofPorts ENUMERATED {p1,p2,p4,p8,p12,p16,p24,p32},
    firstOFDMSymbolInTimeDomain INTEGER (0..13),
    firstOFDMSymbolInTimeDomain2 INTEGER (2..12) OPTIONAL, -- Need R
    cdm-Type ENUMERATED {noCDM, fd-CDM2, cdm4-FD2-TD2, cdm8-FD2-
TD4},
    density CHOICE {
        dot5 ENUMERATED {evenPRBs, oddPRBs},
        one NULL,
        three NULL,
        spare NULL
    },
    freqBand CSI-FrequencyOccupation,
    ...
}
CSI-FrequencyOccupation ::= SEQUENCE
    startingRB INTEGER (0..maxNrofPhysicalResourceBlocks-1),
    nrofRBs INTEGER (24..maxNrofPhysicalResourceBlocksPlus1),
    ...
}
```

For each higher layer signaling in [Table 24], the same or different information may be configured for multiple CSI-RS resources for the UE, and a criterion and definition therefor may be determined according to a combination of at least one of the following items:
The UE may expect that multiple CSI-RS resources have the same value for at least nrofPorts, cdm-Type, density, and nrofRBs in CSI-FrequencyOccupation among the higher layer signalings in [Table 24]; and/or
The UE may expect that multiple CSI-RS resources have the same or different values for at least frequencyDomainAllocation, firstOFDMSymbol InTimeDomain, firstOFDMSymbolInTimeDomain2, and startingRB among the higher layer signalings in [Table 24]

In a method of supporting a total of Pₜₒₜ number of CSI-RS ports by a UE, based on multiple CSI-RS resources, a particular CSI-RS resource among the multiple CSI-RS resources may include all parameters in [Table 6] and [Table 24]. Meanwhile, in relation to a configuration for the remaining CSI-RS resources among the multiple CSI-RS resources, a parameter having the same value as the particular CSI-RS resource may be excluded from the configuration, and a parameter having the same value as the particular CSI-RS resource being excluded from the configuration for the remaining CSI-RS resources may imply that the parameter included in the particular CSI-RS resource and the parameter included in the remaining CSI-RS resource have the same value.

As another method, in a method of supporting a total of Pₜₒₜ number of CSI-RS ports by a UE, based on multiple CSI-RS resources, a particular CSI-RS resource among the multiple CSI-RS resources may include all parameters in [Table 6] and [Table 24], but any parameters may not be configured for the remaining CSI-RS resources among the multiple CSI-RS resources. A time and frequency RE offset are configured for the remaining CSI-RS resources through the particular CSI-RS resource, and thus the remaining CSI-RS resources may express REs to which the remaining CSI-RS ports except for CSI-RS ports expressed by the particular CSI-RS resource among the Pₜₒₜ number of CSI-RS ports are mapped. An RE offset may be a symbol or slot offset, and may be an RE or RB off as frequency resources.

The UE may report, to the base station, a UE capability indicating that the UE supports [Method 1-1] and [Method 1-2] described above. The base station may configure higher layer signaling corresponding to the UE capability for the UE, or may support more than 32 CSI-RS ports, based on a single or multiple CSI-RS resources as described above without a particular higher layer signaling configuration.

### Second Embodiment: Method of CRI Reporting at Time of Channel State Reporting Based on CSI-RS Configured by More than 32 CSI-RS Ports

As an embodiment of the disclosure, a method of CRI reporting at the time of channel state reporting when a UE supports a CSI-RS having 64 or more ports is described. This embodiment may be operated in combination with other embodiments.

The higher layer signaling CSI-ReportConfig may be configured for the UE by a base station, reportQuantity may be configured therefor as a detailed parameter in the higher layer signaling, and one of, for example, none, cri-RI-PMI-CQI, cri-RI-i1, cri-RI-i1-CQI, cri-RI-CQI, cri-RSRP, ssb-Index-RSRP, cri-RI-LI-PMI-CQI, cri-SINR-r16, ssb-Index-SINR-r16, cri-RSRP-Index-r17, ssb-Index-RSRP-Index-r17, cri-SINR-Index-r17, and ssb-Index-SINR-Index-r17 may be possible as reportQuantity. If one of cri-RI-PMI-CQI, cri-RI-i1, cri-RI-CQI, cri-RI-LI-PMI-CQI, cri-SINR-r16, cri-RSRP-Index-r17, and cri-SINR-Index-r17 is configured for the UE as a reportQuantity value, the UE may include a CSI-RS resource indicator (CRI) in a CSI report to be transmitted to the base station. The bit length of the CRI may be determined according to the number of CSI-RS resources included in a CSI-RS resource set.

If the UE supports more than 32 (e.g., 64 or more) CSI-RS ports, a combination of at least one of the following items may be considered for a CRI reporting method of the UE.

[Method 2-1] CSI Reporting without Including CRI

If the higher layer signaling CSI-RS resource set is configurable for the UE by the base station and the UE supports Pₜₒₜ number of CSI-RS ports, which is greater than 32, multiple CSI-RS resources may be configured for the UE in the CSI-RS resource set, and if the number of CSI-RS ports configured in the i-th CSI-RS resource is Pᵢ and there are a total N of CSI-RS resources, P₁+ . . . +P_{N}=Pₜₒₜ may be valid. When the UE transmits a CSI report corresponding to the Pₜₒₜ number of CSI-RS ports to the base station, the UE may generate CSI, based on all the CSI-RS resources in the CSI-RS resource set. Therefore, there is no process of generating, by the UE, CSI by selecting a particular CSI-RS resource among the multiple CSI-RS resources, and thus a CRI report may not be included in the CSI port. In addition, although a CSI-RS resource having Pₜₒₜ number of CSI-RS ports is not configured for the UE in the CSI-RS resource set (i.e., the i-th CSI-RS resource have Pᵢ number of CSI-RS ports which is smaller than Pₜₒₜ), when the UE calculates CSI, the UE may calculate the CSI by considering the number of CSI-RS ports corresponding to the number Pₜₒₜ.
For example, if the UE transmits a CSI report for Pₜₒₜ=64 to the base station, two CSI-RS resources each including 32 CSI-RS ports may be configured for the UE in a CSI-RS resource set, and even though there are two CSI-RS resources in the CSI report transmitted by the UE to the base station, a CRI report may not be included therein. In addition, the UE may calculate CSI corresponding to 64 ports and report same to the base station.

In addition, in a case where the value of the higher layer signaling reportQuantity in CSI-ReportConfig configured for the UE by the base station includes a CRI report, such as cri-RI-PMI-CQI, cri-RI-i1, cri-RI-i1-CQI, cri-RI-CQI, or cri-RI-LI-PMI-CQI, and a CSI-RS resource set includes multiple CSI-RS resources, if the UE performs CSI reporting for Pₜₒₜ greater than 32, the UE may omit the CRI report.
In addition, in a case where a new reportQuantity not including a CRI report, such as RI-PMI-CQI, RI-i1, RI-i1-CQI, RI-CQI, or RI-LI-PMI-CQI, is configured for the UE as the value of the higher layer signaling reportQuantity in CSI-ReportConfig configured by the base station unlike cri-RI-PMI-CQI, cri-RI-i1, cri-RI-i1-CQI, cri-RI-CQI, or cri-RI-LI-PMI-CQI, and a CSI-RS resource set includes multiple CSI-RS resources, if the UE performs CSI reporting for Pₜₒₜ greater than 32, the UE may omit the CRI report.
In addition, in a case where a new reportQuantity including “noCRI” having the meaning that a CRI report is not included, such as noCRI-RI-PMI-CQI, noCRI-RI-i1, noCRI-RI-i1-CQI, noCRI-RI-CQI, or noCRI-RI-LI-PMI-CQI, is configured for the UE as the value of the higher layer signaling reportQuantity in CSI-ReportConfig configured by the base station unlike cri-RI-PMI-CQI, cri-RI-i1, cri-RI-i1-CQI, cri-RI-CQI, or cri-RI-LI-PMI-CQI, and a CSI-RS resource set includes multiple CSI-RS resources, if the UE performs CSI reporting for Pₜₒₜ greater than 32, the UE may omit the CRI report.

### [Method 2-2] CSI Reporting Including CRI and CSI-RS Pair Configuration

If the UE supports Pₜₒₜ number of CSI-RS ports, which is greater than 32, calculates CSI therefor, and reports same to the base station, the UE may perform CSI reporting including a CRI. The higher layer signaling CSI-RS resource set may be configured for the UE by the base station, and if the UE supports Pₜₒₜ number of CSI-RS ports, which is greater than 32, multiple CSI-RS resources each having a maximum of 32 CSI-RS ports may be configured for the UE in the corresponding CSI-RS resource set. The UE may support Pₜₒₜ number of CSI-RS ports through a particular number of CSI-RS resources among the multiple CSI-RS resources. The particular number of CSI-RS resources may be named a CSI-RS pair or group/sub-group, and multiple CSI-RS pairs or groups/sub-groups may be configured for the UE in the CSI-RS resource set. For example, the UE may support Pₜₒₜ=64 number of CSI-RS ports, two or more CSI-RS pairs may be configured therefor in a CSI-RS resource set, each CSI-RS pair may be configured by two CSI-RS resources, and each CSI-RS resource may include 32 CSI-RS ports. When the UE calculates CSI, the UE does not perform calculation for 32 CSI-RS ports configured in each CSI-RS resource set, may perform calculation for a total of 64 CSI-RS ports included in a CSI-RS pair, and may include a CRI for one of all pairs in a CSI report and report same to the base station. For example, the UE may include CRI information in a CSI report, and the bit length of the CRI information may be related to the number of CSI-RS pairs. If a configurable value as a reportQuantity value which may be included in CSI-ReportConfig includes a CRI report, such as cri-RI-PMI-CQI, cri-RI-i1, cri-RI-i1-CQI, or cri-RI-CQI, cri-RI-LI-PMI-CQI, a CSI-RS resource set includes multiple CSI-RS resources, and the number of CSI-RS ports to be used for CSI calculation is greater than 32, the UE may perform CSI reporting including a CRI.

### [Method 2-3] CSI Reporting Including CRI, CSI-RS Group Configuration, and CSI-RS Selection in Each Group

If the UE supports Pₜₒₜ number of CSI-RS ports, which is greater than 32, calculates CSI therefor, and reports same to the base station, the UE may perform CSI reporting including a CRI. Multiple CSI-RS resources may be configured in a CSI-RS resource set for the UE by the base station, and the UE may express a CSI-RS resource having been used for calculation of CSI to be included in the CSI report, by using a CRI. For example, the UE may recognize a CSI-RS resource having been used for calculation of corresponding CSI, by using a bitmap, and if four CSI-RS resources are configured, the UE may mark, as 1, 2 bits among 4 bits capable of representing all the four resources and include same in the CSI report in the form of a CRI, according to the number of antennas (e.g., 64 CSI-RS ports) required for CSI calculation configured for a corresponding CSI report. If a configurable value as a reportQuantity value which may be included in CSI-ReportConfig includes a CRI report, such as cri-RI-PMI-CQI, cri-RI-i1, cri-RI-i1-CQI, or cri-RI-CQI, cri-RI-LI-PMI-CQI, a CSI-RS resource set includes multiple CSI-RS resources, and the number of CSI-RS ports to be used for CSI calculation is greater than 32, the UE may perform CSI reporting including a CRI.

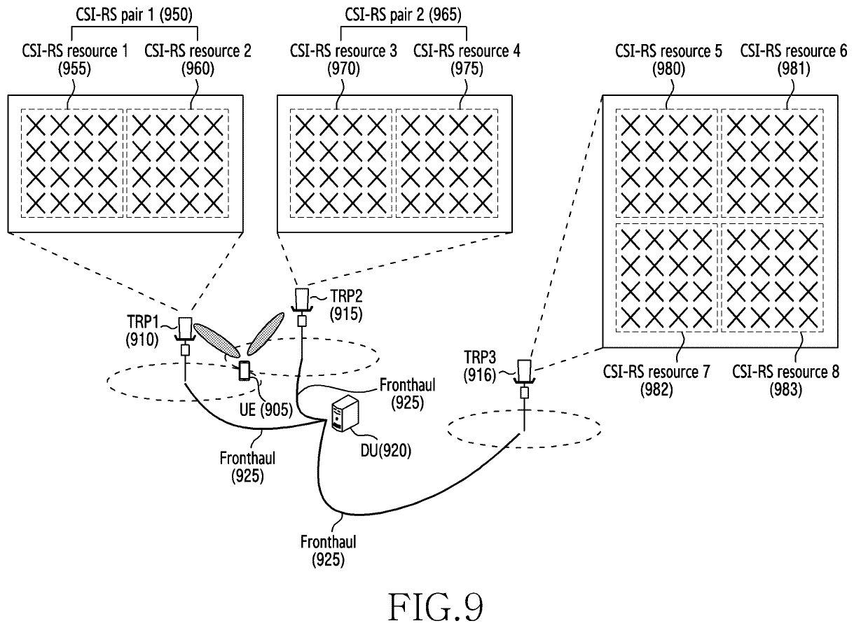

FIG. 9 illustrates a connection relation between an antenna structure of a base station and CSI-RS resources in a wireless communication system according to an embodiment of the disclosure. A UE 905 may receive a CSI-RS from a base station, and transmit a CSI report to the base station. The base station includes two TRPs including TRP 1 910 and TRP 2 915, TRP 3 916, and a distributed unit (DU) 920, the TRPs being connected to the DU, and TRP 1 910, TRP 2 915, and TRP 3 916 are connected to the DU 920 through fronthaul 925. Each of TRP 1 910 and TRP 2 915 may have 64 transmission antennas, and 32 antennas among the 64 antennas are connected to a CSI-RS resource. For example, the left 32 antennas among the 64 antennas of TRP 1 910 are connected to CSI-RS resource 1 955, the right 32 antennas may be connected to CSI-RS resource 2 960, and CSI-RS resource 1 955 and CSI-RS resource 2 960 may be defined to be CSI-RS pair 1 950. Similarly, the left 32 antennas among the 64 antennas of TRP 2 915 are connected to CSI-RS resource 3 970, the right 32 antennas may be connected to CSI-RS resource 4 975, and CSI-RS resource 3 970 and CSI-RS resource 4 975 may be defined to be CSI-RS pair 2 965. CSI-RS resource 1 to CSI-RS resource 4 may be defined in the same CSI-RS resource set for the UE, and the UE may calculate CSI for one of CSI-RS pair 1 or CSI-RS pair 2 and report, to the base station through a CRI report, information of a pair having been identified to have higher performance among the two pairs. In FIG. 9, CSI-RS resource 1 955 and CSI-RS resource 2 960 have been illustrated using, as an example, a case where a parameter (N1) indicating the number of horizontal antennas is 4 and a parameter (N2) indicating the number of vertical antennas is 4. However, an embodiment of the disclosure may include a case where N1 is equal to 8 and N2 is equal to 2. A CSI-RS pair may be configured by CSI-RS resources existing in the same TRP, and for example, CSI-RS resource 1 and CSI-RS resource 2 may configure a CSI-RS pair, but CSI-RS resource 1 and CSI-RS resource 3 are unable to configure a CSI-RS pair. The UE for which a CRI report may exist may perform CSI calculation, based on different CSI-RS ports being transmitted from different TRPs in a case of [Method 2-2]. TRP 3 916 may have a total of 128 transmission antennas, and may be configured by CSI-RS resource 5 to CSI-RS resource 8 each having 32 CSI-RS ports corresponding to N1=N2−4.

The UE and the base station may use [method 2-1] not including the CRI report as a method for supporting single-TRP-based downlink when there are more than 32 antennas in each TRP, for example, TRP 1 910, TRP 2 915, or TRP 3 916. That is, the base station may request the UE to calculate and report CSI for a channel between each TRP and the UE so as to obtain channel information between each TRP and the UE. FIG. 9 defines CSI-RS pair 1 950 and CSI-RS pair 2 965 for [Method 2-2], but may not define a CSI-RS pair, as described above, for [Method 2-1]. Additionally, in a case where the base station is to perform downlink data transmission to the UE in a coherent joint transmission (C-JT) method by using TRP 1 910 and TRP 2 915, CSI-RS resources may be configured for the UE by the base station, based on [Method 2-1], and in order to obtain and report, to the base station, all channel information between the UE and TRP 910 and TRP 2 915, the UE may estimate a channel and calculate CSI by using a total of 128 CSI-RS ports, based on four CSI-RS resources and calculate CSI. CRI information may not be included in the CSI report.

The UE may perform channel estimation for some of a total of 128 transmission antennas in TRP 3 916 for [Method 2-3], and for example, may assume that channel estimation is performed only for 64 antennas. The UE may report a CRI in the form of a bitmap. The bitmap may represent the number of cases of all combinations. However, if an equivalent gap between a horizontal antenna and a vertical antenna is not ensured in the base station (e.g., if CSI-RS resource 5 and CSI-RS resource 8 are selected), the UE may not expect that CRI reporting is performed. For example, the UE may exclude selection autonomously.

Through [Method 2-1], the UE may estimate a channel between a particular TRP and the UE through CSI-RS resources configured by the base station through higher layer signaling, calculate CSI, and report same to the base station. For example, in FIG. 9, CSI-RS resource 1 and CSI-RS resource 2 may be configured in a CSI-RS resource set for the UE by the base station for the use of estimating a channel between TRP 1 910 and the UE, and the UE may perform CSI reporting without a CRI report. In [Method 2-1], CSI-RS pair 1 950 may not be configured. As another example, in FIG. 9, CSI-RS resource 5 to CSI-RS resource 8 may be configured in a CSI-RS resource set for the UE by the base station for the use of estimating a channel between TRP 3 916 and the UE, and the UE may perform CSI reporting without a CRI report.

In addition, through [Method 2-1], the UE may estimate a channel between particular multiple TRPs and the UE through CSI-RS resources configured by the base station through higher layer signaling, calculate CSI, and report same to the base station. This method may be used when the base station is to perform downlink data transmission of the C-JT method for the UE, and the particular multiple TRPs may be considered by the UE as if all antennas of the multiple TRPs operate as one TRP, when the C-JT method is used. For example, in FIG. 9, CSI-RS resource 1 to CSI-RS resource 4 may be configured in a CSI-RS resource set for the UE by the base station for the use of estimating all channels between TRP 1 910 and TRP 2 915 and the UE, and the UE may perform CSI reporting without a CRI report. In [Method 2-1], CSI-RS pair 1 950 and CSI-RS pair 2 965 may not be configured.

In addition, through [Method 2-2] or [Method 2-3], the UE may select one or more TRPs among particular TRPs through CSI-RS resources configured by the base station through higher layer signaling, estimate a channel between the selected one or more TRPs and the UE, calculate CSI, and report same to the base station. The UE may select one or more TRPs, based on a CSI-RS resource configuration configured by the base station to the UE, and report CSI having the highest performance in view of the UE among single TRP or multiple TRP-based CSI, to the base station through a CSI report. In this case, if the UE follows [Method 2-2], the one or more TRPs may be expressed as one CSI-RS pair, and if the UE follows [Method 2-3], the one or more TRPs may be expressed by the value of 1 in a bitmap.

In addition, through [Method 2-2] or [Method 2-3], the UE may select particular antennas among all antennas of particular TRPs through CSI-RS resources configured by the base station through higher layer signaling, estimate a channel between the selected antennas and the UE, calculate CSI, and report same to the base station. The UE may select one or more TRPs, based on a CSI-RS resource configuration configured by the base station to the UE, and report CSI having the highest performance in view of the UE among single TRP or multiple TRP-based CSI, to the base station through a CSI report. In this case, if the UE follows [Method 2-2], the particular antennas among all the antennas may be expressed as one CSI-RS pair, and if the UE follows [Method 2-3], the particular antennas among all the antennas may be expressed by the value of 1 in a bitmap.

In order to allow calculation of CSI for the number of more than 32 CSI-RS ports described above, N1 that is the number of horizontal antennas and N2 that is the number of vertical antennas may be configured, to correspond to Pₜₒₜ, for the UE in codebookConfig in the higher layer signaling CSI-ReportConfig. Although N1 and N2 values are different from the number of CSI-RS ports configured in a CSI-RS resource in the current CSI-RS resource set, since one CSI is required to be calculated based on multiple CSI-RS resources, the values may be configured to be independent of the number of ports of each CSI-RS resource. A possible codebook type may be a Type-I codebook or a Type-II codebook.

With respect to a combination of at least one of [Method 2-1] to [Method 2-3], the UE may report, to the base station, a UE capability indicating that the UE supports the combination. The base station may configure higher layer signaling corresponding to the UE capability for the UE, or may support more than 32 CSI-RS ports, based on a single or multiple CSI-RS resources as described above without a particular higher layer signaling configuration.

The UE may be notified by the base station of a combination of at least one of [Method 2-1] to [Method 2-3] described above through a combination of higher layer signaling, MAC-CE, and L1 signaling, or may fixedly operate according to a method defined in a specification.

### Third Embodiment: Method of Channel Estimation Based on CSI-RS Having 64 or More Ports

As an embodiment of the disclosure, a method of channel estimation when a UE supports a CSI-RS having 64 or more ports is described. This embodiment may be operated in combination with other embodiments.

One or more CSI-RS resources may be configured for a UE in a CSI-RS resource set configured by the base station through higher layer signaling, and accordingly, the UE may consider a combination of at least one of the following items to estimate a channel for Pₜₒₜ number of CSI-RS ports, which are a total sum of CSI-RS ports representable by respective multiple CSI-RS resources, based on the CSI-RS resources.

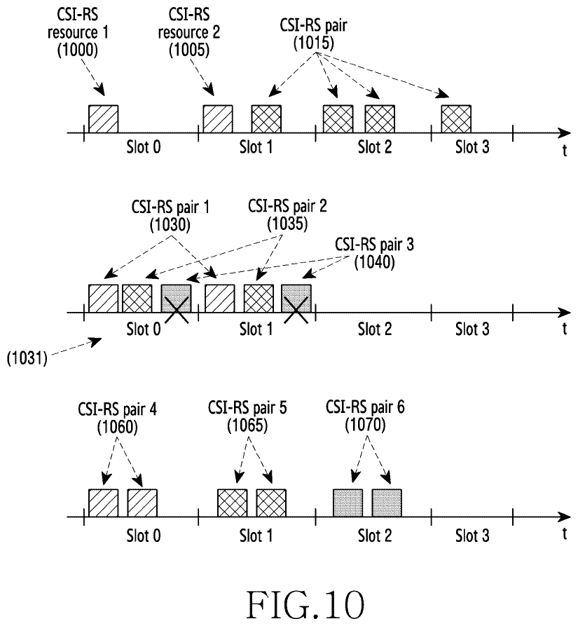

FIG. 10 illustrates restrictions on CSI-RS resource reception and channel estimation in a wireless communication system according to an embodiment of the disclosure. The restrictions related to CSI-RS resource reception and channel estimation illustrated in FIG. 10 may be considered to be referred to when the following methods are described.

### [Method 3-1]

At the time of CSI calculation for 32 or more CSI-RS ports, based on multiple CSI-RS resources, the UE may expect that the multiple CSI-RS resources are received within a particular time. If the UE operates in a TDD band, the UE may expect that there is no switching between downlink and uplink while the multiple CSI-RS resources are received, and this may imply that the UE is expected to operate only on a downlink symbol or slot while multiple CSI-RS resources are received. If an uplink subband is configured for the UE, the UE may be expected to operate, while the multiple CSI-RS resources are received, only on a downlink symbol or slot on which the uplink subband does not exist in the time resources, or only on a downlink symbol or slot on which the uplink subband exists.
More specifically, the UE may expect that the time difference between the first symbol or last symbol of a firstly received CSI-RS resource among multiple CSI-RS resources, and the first symbol or last symbol of a lastly received CSI-RS resource is within a particular value. The value may be a value of a particular number of symbols, slots, or absolute time units.
As another method, the UE may expect that the multiple CSI-RS resources are received on the same slot, or are received in consecutive N number of slots, and N may be 2 or 3 for example. The number of slots may be restricted to be the same regardless of the number of CSI-RS resources. For example, if the UE performs CSI reporting for 64 CSI-RS ports by using two CSI-RS resources each having 32 CSI-RS ports, the UE may expect that the two CSI-RS resources are all received on one slot or in consecutive two slots. As another example, if the UE performs CSI reporting for 128 CSI-RS ports by using four CSI-RS resources each having 32 CSI-RS ports, the UE may expect that the four CSI-RS resources are all received on one slot or in consecutive two slots.
As another method, when the UE performs channel estimation and CSI reporting for all CSI-RS ports, based on multiple CSI-RS resources, the UE may consider different numbers of consecutive slots that are restricted when the multiple CSI-RS resources are received, according to the number of the CSI-RS resources. For example, when the UE performs channel estimation for 64 CSI-RS ports by using CSI-RS resource 1 1000 and CSI-RS resource 2 1005 each having 32 CSI-RS ports, the UE may expect that CSI-RS resources 1 and 2 are both received in one or two consecutive slots. As another example, when the UE performs channel estimation for 128 CSI-RS ports by using a CSI-RS pair 1015 four CSI-RS resources each having 32 CSI-RS ports, the UE may expect that the CSI-RS pair is entirely received in three consecutive slots. The restriction that the two CSI-RS resources and the four CSI-RS resources are required to be all received in two and three consecutive slots, respectively merely corresponds to an example, and there may be a restriction of a different number of consecutive slots for each case.

### [Method 3-2]

If the UE performs CSI calculation for more than 32 CSI-RS ports, based on multiple CSI-RS resources, in a case where the UE receives multiple CSI-RS pairs, selects one or more CSI-RS pairs thereamong, includes the selected pairs in a CSI report in the form of a CRI report, and transmits same to the base station, when multiple CSI-RS resources configuring the respective multiple CSI-RS pairs are alternately transmitted to the UE, the UE may consider a restriction on a maximum number of CSI-RS resources or a maximum number of CSI-RS ports at the time of reception of some CSI-RS resources in each CSI-RS pair among all the CSI-RS pairs. This may consider that when the UE performs channel estimation for all CSI-RS ports, based on multiple CSI-RS resource, if there are CSI-RS resources having not been received yet in a situation where some CSI-RS resources have already been received, there is a burden of being required to store the already received CSI-RS resources in a buffer before the remaining CSI-RS resources are received.

For example, a case where CSI-RS pair 1 1030, CSI-RS pair 2 1035, and CSI-RS pair 3 1040 may be configured for the UE by the base station, each CSI-RS pair is configured by two CSI-RS resources, and each CSI-RS resource includes 32 CSI-RS ports may be considered. In a case where the UE considers 64 as a maximum number of a total number of CSI-RS ports of some CSI-RS resources, which have been previously received, among multiple CSI-RS resources in all the CSI-RS pairs in consideration of the burden of a buffer, in a situation where the UE has received the first CSI-RS resources in CSI-RS pair 1 1030 and CSI-RS pair 2 1035 on slot 0 1031 in FIG. 10 and has not received the second CSI-RS resources of CSI-RS pair 1 1030 and CSI-RS pair 2 1035 yet, the number of CSI-RS ports has reached 64 that is a maximum number restriction, and thus the UE may fail to receive the first CSI-RS resource of CSI-RS pair 3 1040 which may be received on slot 0 1031. Such the restriction is related to a storage of the UE and thus the UE may enable the base station to recognize same through a capability report of the UE, and the base station may configure multiple CSI-RS pairs not to exceed a maximum number restriction of CSI-RS ports, based thereon. For example, the base station may configure CSI-RS pairs not to be alternately received. In this case, a restriction value reported by the UE may not only consider CSI-RS pairs but also a single CSI-RS resource having 32 or less CSI-RS ports or more than 32 CSI-RS ports. For example, if the UE has received the first CSI-RS resources in CSI-RS pair 1 1030 and CSI-RS pair 2 1035, as described above, on slot 0 1031, and thus has already reached a maximum number of CSI-RS ports considerable by the UE, the UE is unable to receive any other CSI-RSs as well as the first CSI-RS resource of CSI-RS pair 3 1040 until the second CSI-RS resource of CSI-RS pair 1 1030 is received, a channel is estimated, and the buffer is emptied out.

### [Method 3-3]

If the UE performs CSI calculation for more than 32 CSI-RS ports, based on multiple CSI-RS resources, in a case where the UE receives multiple CSI-RS pairs, selects one or more CSI-RS pairs thereamong, includes the selected pairs in a CSI report in the form of a CRI report, and transmits same to the base station, the UE may expect that all CSI-RS resources in a CSI-RS pair are continuously received, and may be unable to receive a combination of at least one of CSI resources in different CSI-RS pairs among all the CS-RS resources, a single CSI-RS resource, or another downlink channel. For example, CSI-RS pair 4 1060, CSI-RS pair 5 1065, and CSI-RS pair 6 1070 are each configured by two CSI-RS resources, may be transmitted to the UE on slot 0, slot 1, and slot 2, respectively, and another downlink signal is not received while all CSI-RS resources included in each CSI-RS pair are received.

The UE may consider a channel estimation restriction on the time resources considering multiple CSI-RS resources in addition to [Method 3-1] to [Method 3-3].

If timeRestrictionForChannelMeasurements in the higher layer signaling CSI-ReportConfig is configured for the UE to be notConfigured, the UE may calculate CSI, based on a CSI-RS resource previously received by the UE rather than being based on a CSI reference resource for a CSI report.

If timeRestrictionForChannelMeasurements in the higher layer signaling CSI-ReportConfig is configured for the UE to be Configured, the UE may calculate CSI, based on a CSI-RS resource having been received immediately before receiving a CSI reference resource for a CSI report. In this case, when the UE performs CSI reporting, based on more than 32 CSI-RS port, based on multiple CSI-RS resources, the UE calculates CSI by estimating a channel only for a CSI-RS resource having been received immediately before a CSI reference resource, and thus the UE may obtain only as many channels as the number of CSI-RS ports included in the CSI-RS resource.

If timeRestrictionForChannelMeasurements in the higher layer signaling CSI-ReportConfig is configured for the UE to be Configured, the UE may calculate CSI, based on a CSI-RS resource having been received immediately before receiving a CSI reference resource for a CSI report. The CSI-RS resource having been received immediately before the CSI reference resource may be applied to all CSI-RS resources included in a CSI resource set configured in CSI-ReportConfig. Therefore, the UE may perform channel estimation for a CSI-RS resource having been received immediately before receiving a CSI reference resource at a reception position of the CSI-RS resource with respect to all CSI-RS resources included in a CSI resource set. For this operation, additional higher layer signaling may be configured for the UE, or if a CSI-RS resource set connected to CSI-ReportConfig is for CSI calculation for more than 32 CSI-RS ports, the UE may apply a channel estimation restriction on the time resources to all CSI-RS resources included in the CSI resource set without additional higher layer signaling.

Various embodiments of the disclosure may be similarly applied to not only a case where channel estimation, CSI calculation, and reporting for more than 32 CSI-RS ports are performed, but also a case where the UE receives multiple CSI-RS resources for group-based beam reporting, a case where the UE receives multiple CSI-RS resources for Type-II CJT CSI reporting, or a case where the UE receives multiple CSI-RS resources for NCJT CSI reporting.

At the time of channel estimation, CSI calculation, and reporting for more than 32 CSI-RS ports, in a case where a codebook type is Type-I or Type-II, the UE may use Z₂, Z′₂ values in [Table 14] without change, use values such as Z₂+d1, Z′₂+d2 in consideration of an additional delay value for the Z₂, Z′₂ values, or use values such as a1Z₂, a2Z′₂ in consideration of constant values multiplied to the Z₂, Z′₂ values. In this case, d1 and d2 or a1 and a2 may be reported as a UE capability, or fixedly defined in a specification, and the values of d1 and d2 or a1 and a2 may be differently determined according to the number of CSI-RS ports, the number of multiple CSI-RS resources when they are used, and a subcarrier spacing.

At the time of channel estimation, CSI calculation, and reporting for more than 32 CSI-RS ports, based on multiple CSI-RS resources as in [Method 1-2], when CPU calculation is performed, the UE may calculate the number of CPUs according to the number of CSI-RS resources, or may consider 1 as the number of CSI-RS resources at the time of CPU calculation even when the UE uses multiple CSI-RS resources.

At the time of channel estimation, CSI calculation, and reporting for more than 32 CSI-RS ports, based on a single CSI-RS resource as in [Method 1-1], when CPU calculation is performed, the UE may calculate the number of CPUs as 1 equal to the number of CSI-RS resources, or even when multiple CSI-RS resource are not used, may calculate the number of CPUs as a value obtained by dividing the number of CSI-RS ports included in the CSI-RS resource by 32 CSI-RS ports.

The UE may transmit, to the base station through a UE capability report, a restriction on the number of CSI-RS resources simultaneously activatable in each cell and a restriction on the number of CSI-RS ports simultaneously activatable in each cell. The UE may report, to the base station, a natural number among 1 to 32 as the number of CSI-RS resources simultaneously activatable in each cell. The UE may report, to the base station, a multiple of 8 among 8 to 128 as the number of CSI-RS ports simultaneously activatable in each cell. Whether the UE receives multiple aperiodic CSI-RS resources on one slot or receives one aperiodic CSI resource on each slot, the UE may receive an aperiodic CSI-RS resource triggered through a PDCCH from the base station under the restrictions on the number of CSI-RS resources and the number of CSI-RS ports.

A particular CSI-RS resource having been activated may be differently defined according to each time domain behavior as described below, and the UE may assume that a configured number of ports have been activated in a CSI-RS resource having been activated as described below:
With respect to an aperiodic CSI-RS resource, it may be defined that the CSI-RS resource has been activated for the UE from the end time point of the last symbol of a PDCCH including trigger information for the CSI-RS resource, to the end time point of the last symbol of PUSCH transmission including an aperiodic CSI report based on the CSI-RS resource;
With respect to a semi-persistent CSI-RS resource, it may be defined that the CSI-RS resource has been activated for the UE from a time point at which an activation command for the CSI-RS resource is applied, to a time point at which a deactivation command is applied. In this case, the UE may receive the activation command and the deactivation command for the semi-persistent CSI-RS resource through a MAC-CE. Therefore, it may be assumed that activation and deactivation commands are applied to the UE after 3 ms after transmission of a PUCCH including HARQ-ACK information for reception of a MAC-CE including the activation and deactivation commands; and/or
With respect to a periodic CSI-RS resource, it may be defined that the CSI-RS resource has been activated for the UE from a time point at which the CSI-RS resource is configured through higher layer signaling, to a moment at which the higher layer signaling is released.

If a particular CSI-RS resource is used a total of N times in one or more CSI report configurations (here, N may be a natural number), when the number of activated CSI-RS resources and the number of activated CSI-RS ports are calculated, the UE may apply N times to the CSI-RS resource and the number of ports of the CSI-RS resource.

At the time of channel estimation, CSI calculation, and reporting for more than 32 CSI-RS ports, based on multiple CSI-RS resources as in [Method 1-2], when the number of activated CSI-RS resources is calculated, the UE may calculate same as the number of the CSI-RS resources, or since one CSI is calculated even when the UE uses multiple CSI-RS resources, the UE may consider 1 as the number of the CSI-RS resources to calculate the number of the activated CSI-RS resources. In addition, when the number of activated CSI-RS ports is calculated, the UE may consider, as the number, a total number of CSI-RS ports greater than 32.

At the time of channel estimation, CSI calculation, and reporting for more than 32 CSI-RS ports, based on a single CSI-RS resource as in [Method 1-1], when the number of activated CSI-RS resources is calculated, the UE may calculate same as 1 equal to the number of CSI-RS resources, or even when multiple CSI-RS resources are not used, may calculate the number of the activated CSI-RS resources as a value obtained by dividing the number of CSI-RS ports included in the CSI-RS resource by 32 CSI-RS ports. In addition, when the number of activated CSI-RS ports is calculated, the UE may consider, as the number, a total number of CSI-RS ports greater than 32.

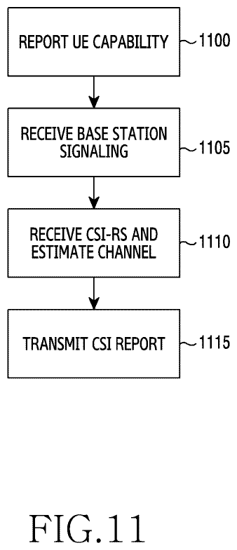

FIG. 11 illustrates an operation of a UE according to an embodiment of the disclosure.

In operation 1100, a UE may report a UE capability to a base station. The UE capability that the UE may report to the base station may be related to a maximum number of CSI-RS resources and a maximum number of CSI-RS ports per cell or bandwidth part, a codebook type supported by the UE (e.g., Type-I or Type-II), [Method 1-1], [Method 1-2], [Method 2-1] to [Method 2-3], [Method 3-1] to [Method 3-3], a channel estimation restriction on the time resources considering multiple CSI-RS resources described above, a CSI computation time, a CPU occupation, or a method of calculating the number of activated CSI-RS ports and the number of activated CSI-RS resource.

In operation 1105, the UE may receive base station signaling from the base station. The base station signaling may indicate a combination of at least one of higher layer signaling, MAC-CE signaling, and L1 signaling, and the higher layer signaling, the MAC-CE signaling, and the L1 signaling may relate to CSI report-related information (e.g., CSI-ReportConfig, and reportQuantity, codebookConfig, etc. in the parameter), [Method 1-1], [Method 1-2], [Method 2-1] to [Method 2-3], [Method 3-1] to [Method 3-3], a channel estimation restriction on the time resources considering multiple CSI-RS resources described above, a CSI computation time, a CPU occupation, or a method of calculating the number of activated CSI-RS ports and the number of activated CSI-RS resource.

In operation 1110, the UE may receive the number of one or more activated CSI-RS resources transmitted from the base station, and perform channel estimation therefor. The UE may receive, from the base station, base station signaling related to a single or multiple CSI-RS resources for channel estimation and CSI calculation for more than 32 CSI-RS ports by considering a combination of at least one of [Method 1-1], [Method 1-2], and [Method 3-1] to [Method 3-3], and may consider a channel estimation method and restriction when multiple CSI-RS resources are received, based on a combination of at least one of [Method 3-1] to [Method 3-3].

In operation 1115, the UE may calculate CSI, based on an estimated channel and transmit a CSI report to the base station. The UE may calculate CSI including or not including a CRI by considering [Method 1-1], [Method 1-2], [Method 2-1] to [Method 2-3], or a CSI computation time described above, and may transmit a CSI report to the base station, based on the calculated CSI. The calculated CSI may be based on a Type-I or a Type-II codebook.

A flowchart described above illustrates an exemplified method implementable according to the principle of the disclosure, and a method illustrated in the flowchart of this specification may be variously modified. For example, a series of operations are illustrated, but various operations in each drawing may overlap with each other, occur in parallel, occur in a different sequence, or occur several times. In another example, an operation may be omitted or replaced with another operation.

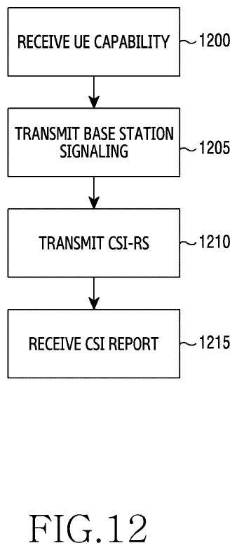

FIG. 12 illustrates an operation of a base station according to an embodiment of the disclosure.

In operation 1200, a base station may receive a UE capability from a UE. The UE capability that the base station may receive from the UE may be related to a maximum number of CSI-RS resources and a maximum number of CSI-RS ports per cell or bandwidth part, a codebook type supported by the UE (e.g., Type-I or Type-II), [Method 1-1], [Method 1-2], [Method 2-1] to [Method 2-3], [Method 3-1] to [Method 3-3] described above, a channel estimation restriction on the time resources considering multiple CSI-RS resources described above, a CSI computation time, a CPU occupation, or a method of calculating the number of activated CSI-RS ports and the number of activated CSI-RS resource.

In operation 1205, the base station may transmit base station signaling to the UE. The base station signaling may indicate a combination of at least one of higher layer signaling, MAC-CE signaling, and L1 signaling, and the higher layer signaling, the MAC-CE signaling, and the L1 signaling may relate to CSI report-related information (e.g., CSI-ReportConfig, and reportQuantity, codebookConfig, etc. in the parameter), [Method 1-1], [Method 1-2], [Method 2-1] to [Method 2-3], [Method 3-1] to [Method 3-3] described above, a channel estimation restriction on the time resources considering multiple CSI-RS resources, a CSI computation time, a CPU occupation, or a method of calculating the number of activated CSI-RS ports and the number of activated CSI-RS resource.

In operation 1210, the base station may consider that the UE is to receive one or more CSI-RS resources transmitted to the UE and perform channel estimation therefor. The base station may transmit, to the UE, the base station signaling related to a single or multiple CSI-RS resources for channel estimation and CSI calculation for more than 32 CSI-RS ports by considering a combination of at least one of [Method 1-1], [Method 1-2], and [Method 3-1] to [Method 3-3] described above, and the UE may consider a channel estimation method and restriction when multiple CSI-RS resources are received, based on a combination of at least one of [Method 3-1] to [Method 3-3].

In operation 1215, the base station may receive, through a CSI report, CSI calculated based on a channel estimated by the UE. The base station may consider that the UE is to calculate CSI including or not including a CRI by considering [Method 1-1], [Method 1-2], [Method 2-1] to [Method 2-3], or a CSI computation time described above, and the base station may receive a CSI report, based on the consideration. The calculated CSI may be based on a Type-I or a Type-II codebook.

A flowchart described above illustrates an exemplified method implementable according to the principle of the disclosure, and a method illustrated in the flowchart of this specification may be variously modified. For example, a series of operations are illustrated, but various operations in each drawing may overlap with each other, occur in parallel, occur in a different sequence, or occur several times. In another example, an operation may be omitted or replaced with another operation.

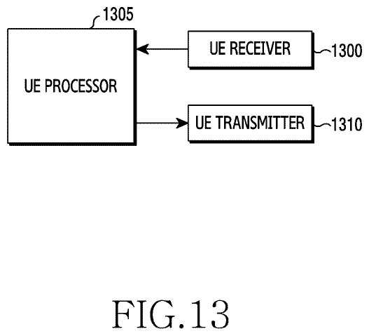

FIG. 13 illustrates a structure of a UE in a wireless communication system according to an embodiment of the disclosure.

Referring to FIG. 13, the UE may include a transceiver, which refers to a UE receiver 1300 and a UE transmitter 1310 as a whole, a memory (not illustrated), and a UE processor 1305 (or UE controller or processor). The UE receiver and the UE transmitter 1300 and 1310, the memory, and the UE processor 1305 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

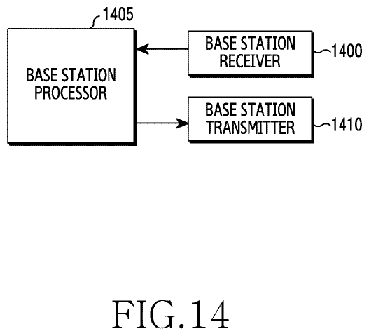

FIG. 14 illustrates a structure of a base station in a wireless communication system according to an embodiment of the disclosure.

Referring to FIG. 14, the base station may include a transceiver, which refers to a base station receiver 1400 and a base station transmitter 1410 as a whole, a memory (not illustrated), and a base station processor 1405 (or base station controller or processor). The base station receiver and transmitter 1400 and 1410, the memory, and the base station processor 1405 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A user equipment (UE) in a wireless communication system, the UE comprising:
a transceiver; and
a controller coupled to the transceiver, and configured to:
receive, from a base station, information configuring a channel state information-reference signal (CSI-RS) resource with more than 32 antenna ports, wherein the CSI-RS resource is an aggregation of a plurality of CSI-RS resources, and
receive, from the base station, a CSI-RS on the CSI-RS resource,
wherein each of the plurality of CSI-RS resources has an equal number of antenna ports, and
wherein a number of the plurality of CSI-RS resources is one of two, three, or four.

2. The UE of claim 1, wherein each of the plurality of CSI-RS resources has at least one of a same power control offset value, a same power control offset value for a synchronization signal, or a same quasi co-located (QCL) value.

3. The UE of claim 1, wherein a CSI processing time for the CSI-RS resource with more than 32 antenna ports is scaled based on a total number of antenna ports for the plurality of CSI-RS resources, and
wherein a CSI processing unit (CPU) occupation is determined according to a value of the total number of antenna ports divided by 32.

4. The UE of claim 1, wherein, in case that information on a time restriction for channel measurements is received, an occasion for each of the plurality of CSI-RS resources for computing a CSI report is located most recent and no later than an occasion for a CSI reference resource.

5. A base station in a wireless communication system, the base station comprising:
a transceiver; and
a controller coupled to the transceiver, and configured to:
transmit, to a user equipment (UE), information configuring a channel state information-reference signal (CSI-RS) resource with more than 32 antenna ports, wherein the CSI-RS resource is an aggregation of a plurality of CSI-RS resources, and
transmit, to the UE, a CSI-RS on the CSI-RS resource,
wherein each of the plurality of CSI-RS resources has an equal number of antenna ports, and
wherein a number of the plurality of CSI-RS resources is one of two, three, or four.

6. The base station of claim 5, wherein each of the plurality of CSI-RS resources has at least one of a same power control offset value, a same power control offset value for a synchronization signal, or a same quasi co-located (QCL) value.

7. The base station of claim 5, wherein a CSI processing time for the CSI-RS resource with more than 32 antenna ports is scaled based on a total number of antenna ports for the plurality of CSI-RS resources, and
wherein a CSI processing unit (CPU) occupation is determined according to a value of the total number of antenna ports divided by 32.

8. The base station of claim 5, wherein, in case that information on a time restriction for channel measurements is transmitted, an occasion for each of the plurality of CSI-RS resources for computing a CSI report is located most recent and no later than an occasion for a CSI reference resource.

9. A method performed by a user equipment (UE) in a wireless communication system, the method comprising:
receiving, from a base station, information configuring a channel state information-reference signal (CSI-RS) resource with more than 32 antenna ports, wherein the CSI-RS resource is an aggregation of a plurality of CSI-RS resources; and
receiving, from the base station, a CSI-RS on the CSI-RS resource,
wherein each of the plurality of CSI-RS resources has an equal number of antenna ports, and
wherein a number of the plurality of CSI-RS resources is one of two, three, or four.

10. The method of claim 9, wherein each of the plurality of CSI-RS resources has at least one of a same power control offset value, a same power control offset value for a synchronization signal, or a same quasi co-located (QCL) value.

11. The method of claim 9, wherein a CSI processing time for the CSI-RS resource with more than 32 antenna ports is scaled based on a total number of antenna ports for the plurality of CSI-RS resources, and
wherein a CSI processing unit (CPU) occupation is determined according to a value of the total number of antenna ports divided by 32.

12. The method of claim 9, wherein, in case that information on a time restriction for channel measurements is received, an occasion for each of the plurality of CSI-RS resources for computing a CSI report is located most recent and no later than an occasion for a CSI reference resource.

13. A method performed by a base station in a wireless communication system, the method comprising:
transmitting, to a user equipment (UE), information configuring a channel state information-reference signal (CSI-RS) resource with more than 32 antenna ports, wherein the CSI-RS resource is an aggregation of a plurality of CSI-RS resources; and
transmitting, to the UE, a CSI-RS on the CSI-RS resource,
wherein each of the plurality of CSI-RS resources has an equal number of antenna ports, and
wherein a number of the plurality of CSI-RS resources is one of two, three, or four.

14. The method of claim 13, wherein each of the plurality of CSI-RS resources has at least one of a same power control offset value, a same power control offset value for a synchronization signal, or a same quasi co-located (QCL) value.

15. The method of claim 13, wherein a CSI processing time for the CSI-RS resource with more than 32 antenna ports is scaled based on a total number of antenna ports for the plurality of CSI-RS resources, and
wherein a CSI processing unit (CPU) occupation is determined according to a value of the total number of antenna ports divided by 32.

16. The method of claim 13, wherein, in case that information on a time restriction for channel measurements is transmitted, an occasion for each of the plurality of CSI-RS resources for computing a CSI report is located most recent and no later than an occasion for a CSI reference resource.
